(19) United States
(12) Patent Application Publication
(10) Pub. No.: US 2016/0275637 A1
(43) Pub. Date: Sep. 22, 2016

(54) CLAIMS DATA ANONYMIZATION AND ALIASING ANALYTICS APPARATUSES, METHODS AND SYSTEMS

(71) Applicant: EVARIANT, INC., Farmington, CT (US)

(72) Inventors: A. Robert Grant, Avon, CT (US); Bill Moschella, Avon, CT (US); Jeff McDonald, Centerville, TN (US)

(73) Assignee: EVARIANT, INC., Farmington, CT (US)

(21) Appl. No.: 15/033,515

(22) PCT Filed: Nov. 3, 2014
(86) PCT No.: PCT/US2014/063760

§ 371 Date: Apr. 29, 2016

Related U.S. Application Data
(60) Provisional application No. 61/899,092, filed on Nov. 1, 2013.

(51) Int. Cl. G06Q 50/22; G06Q 40/08; G06Q 30/02; G06F 21/62

(52) U.S. Cl. CPC G06Q 50/22; G06F 21/6254; G06Q 40/08; G06Q 30/0201

(57) ABSTRACT

Methods and systems for anonymizing claims data and aliasing analytics comprise extracting claims data; anonymizing the extracted data; assigning a plurality of aliases to the anonymized claims data; analyzing the anonymized extracted claims data; determining characteristics of referrals in longitudinal referral records; aggregating the longitudinal referral records; identifying a loyalty to a client; and generating providers scores indicating the loyalty. The disclosure provides claims-based data analytics to characterize a healthcare market place and participants therein. The analysis of the claims data are performed across providers, service lines, geographic markets areas, time frames, and sites of service.

This application is a non-provisional of and claims priority under 35 USC §119 to: U.S. provisional patent application Ser. No. 61/899,092 filed Nov. 1, 2013, entitled “HEALTHCARE PROVIDERS CLAIMS ANALYTICS APPARATUSES, METHODS AND SYSTEMS,” attorney docket no. EVAR-001/00US 317132-2001.

The entire contents of the aforementioned application(s) are expressly incorporated by reference herein.

This application may contain material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### BACKGROUND

Patients in need of attention for various health issues receive treatments from health care providers. If the patient is covered by health insurance, the providers submit health insurance claim forms to the insurance carrier to receive compensation for the services they provided.

### FIELDS OF INVENTIONS

To protect the identities of patients and provide security to healthcare data, in some embodiments, claim forms and/or data extracted from claim forms may be anonymized to mask patient identities. However, longitudinal referral records are constructed by analyzing multiple data sets from same patient. As such, an aliasing mechanism that masks the identities of patients on the claims data but establishes the relationship between the data (e.g., two sets of data come from same patient but refer to visits to separate providers, etc.) may be used to uniquely yet anonymously identify claims data belonging to same patients. In some instances, analysis of such anonymous, secure data may produce actionable intelligence on the state of a healthcare marketplace.

### BRIEF DESCRIPTION OF THE DRAWINGS

FIG. 1 shows an example data flow illustrating claims data extraction and analysis, in one embodiment;

FIG. 2 shows an example logic flow illustrating aspects of claims data extraction, e.g., an example CDEI Component, in one embodiment;

FIGS. 3A-B shows an example logic flow illustrating aspects of claims data aggregation and analysis, e.g., an example CDAA Component, in one embodiment;

FIG. 4 shows an example schematic illustrating aspects of longitudinal patient encounters and referrals, in one embodiment;

FIGS. 5A-G show example user interface (UI) screenshots illustrating implementations of aspects of CD3A, in one embodiment; and

FIG. 6 shows a block diagram illustrating aspects of an exemplary embodiment of a CD3A user interface controller, in one embodiment.

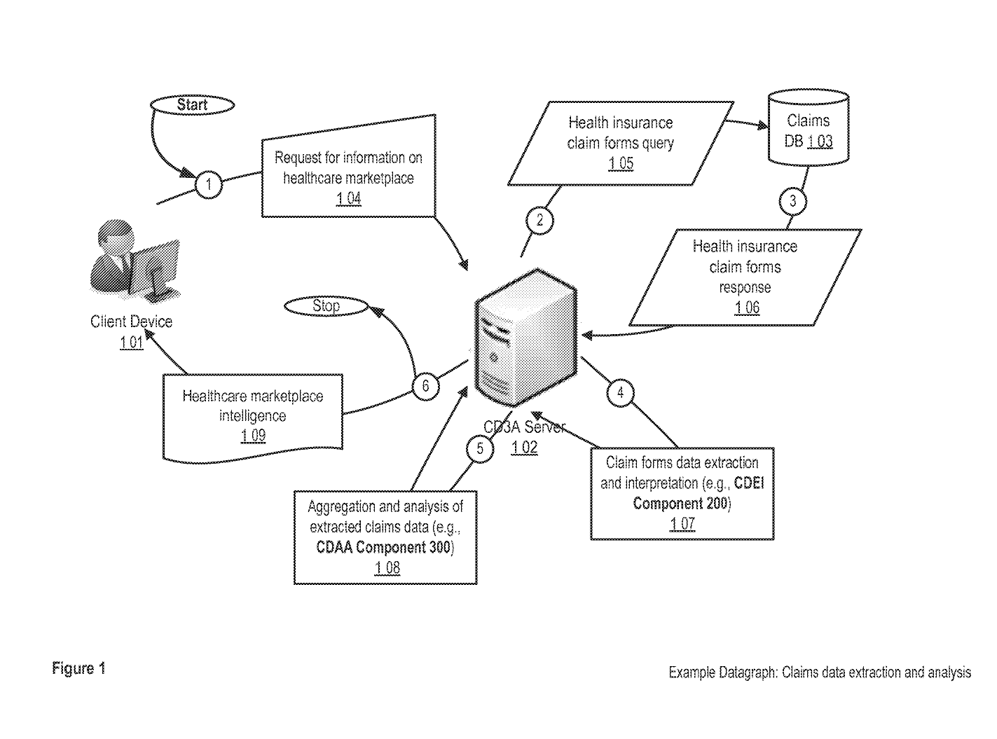

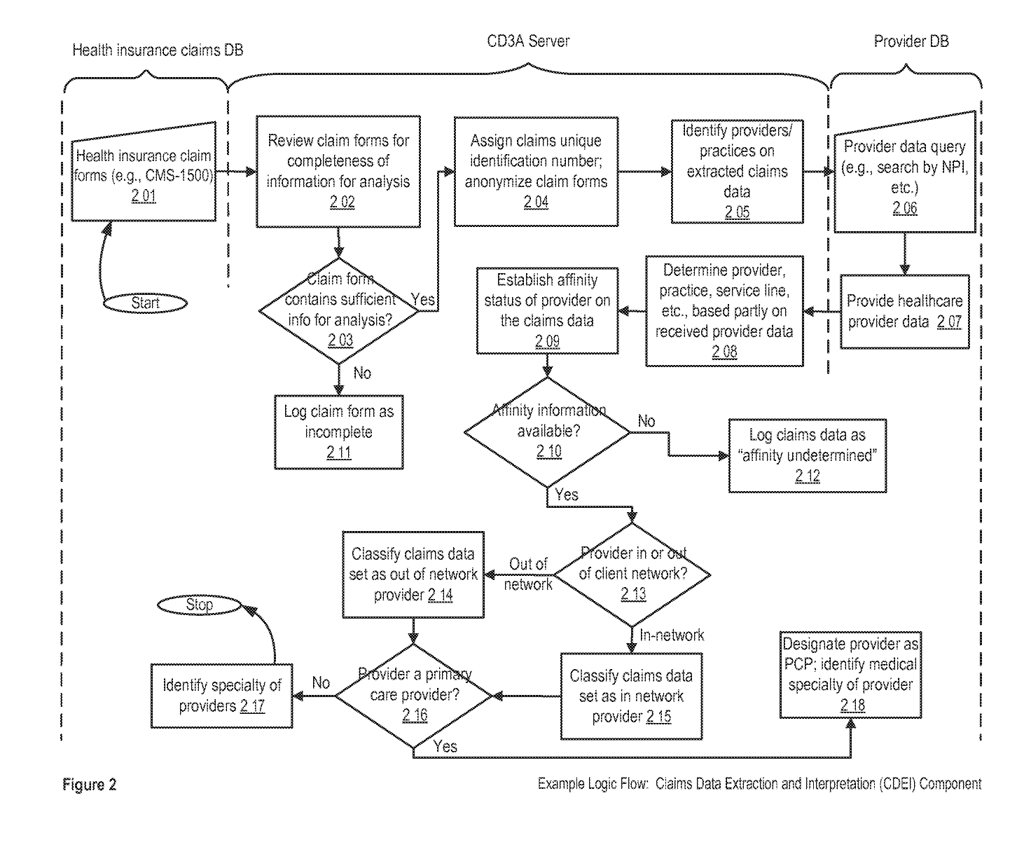

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2A, 2B, etc.

### DETAILED DESCRIPTION

In some embodiments, an CLAIMS DATA ANONYMIZATION AND ALIASING ANALYTICS APPARATUSES, METHODS AND SYSTEMS (hereinafter “CD3A”) transform healthcare claims data, via CD3A components, into analytics on healthcare service participants and the networks there between.

In some embodiments, a healthcare provider, such as a primary care physician (PCP), a specialist, etc., may render a healthcare service to a patient and submit an insurance claims form to an insurer of the patient to receive compensation for the services rendered. For example, the provider may submit the Health Insurance Portability and Accountability Act (HIPPA) compliant standard health insurance claim form CMS-1500 that includes patient information, physician/practice identifiers such as national provider identifier (NPI) numbers, names and addresses of providers, diagnosis and treatment data such as diagnosis and procedure codes (e.g., current procedural terminology (CPT) codes, diagnostic related group (DRG) codes, and/or international classification of diseases (ICD) codes, etc.), referral data (e.g., information on referring physicians, etc.), etc. In some instances, a single visit to a healthcare provider may initiate a large number of claims containing a large amount of healthcare data related to the patient, the provider, the payor, the service lines, etc. The provider may further refer the patient to another provider, leading to additional claims. For example, a PCP may refer a patient to a specialist, who may, after providing service to the patient, further refer the patient to a subspecialist. These visits to healthcare providers generate claim forms to be submitted to payor(s), with most or all forms listing a plethora of healthcare data including identifying information of the referring providers.

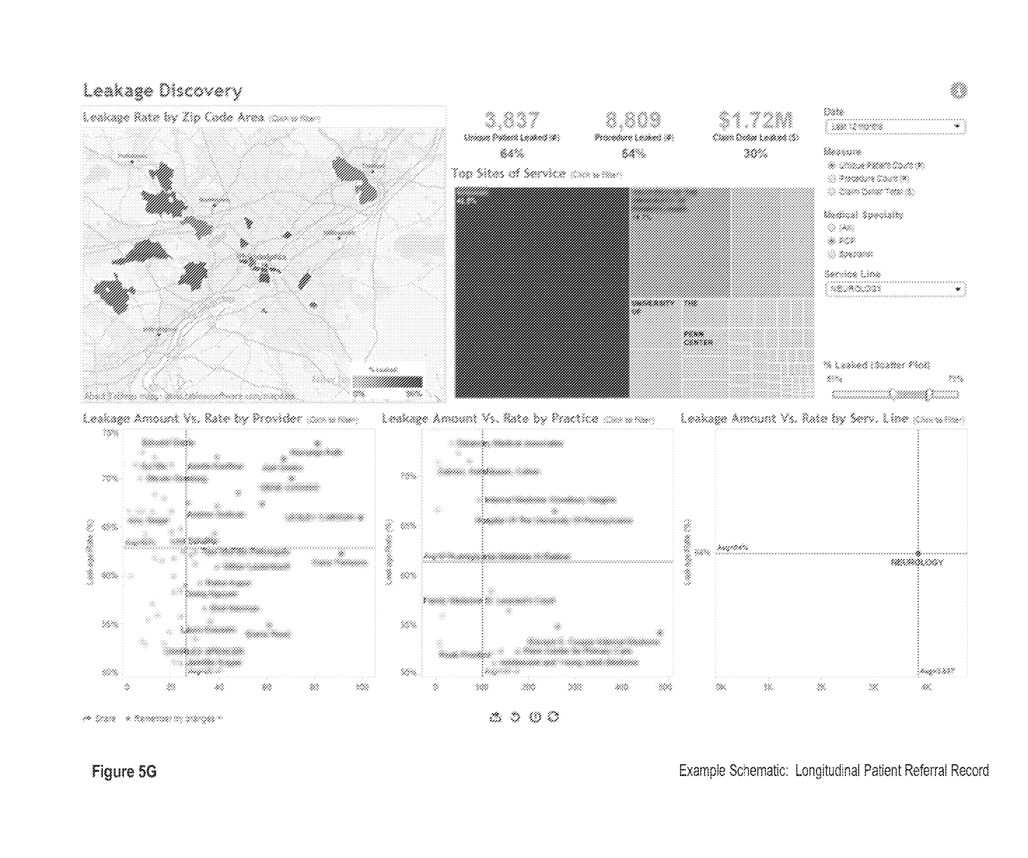

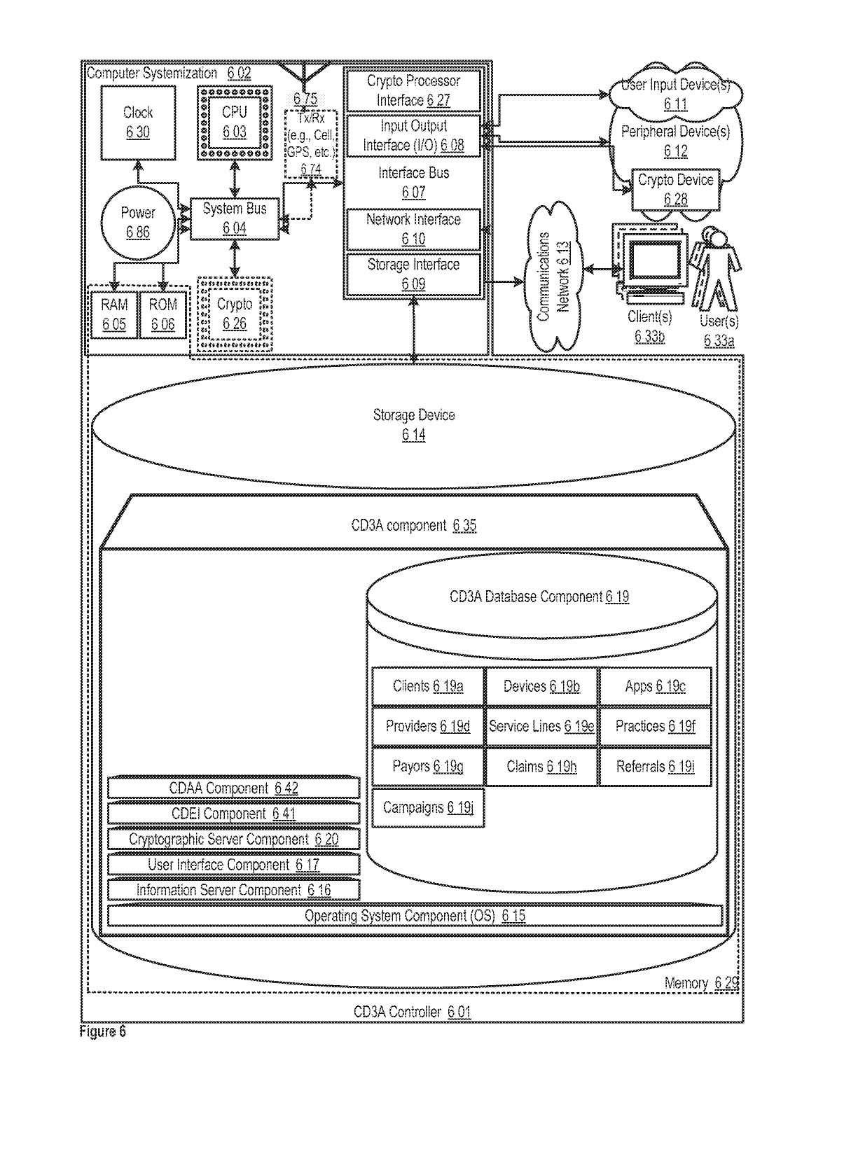

FIG. 1 shows an example data flow illustrating claims data extraction and analysis, in some embodiments of the CD3A. In one embodiment, a client device 101 may request for information on the status of a healthcare marketplace in a selected region during some timeframe, e.g., 104. A client may be a healthcare provider (e.g., physicians, practices, healthcare organizations, etc.) seeking to obtain information and/or intelligence on the state of a healthcare marketplace and/or its participants. For example, the client may request via a client device 101 information on participants, which in some instances may include the client itself, of a healthcare marketplace such as but not limited to providers, practices, patients, payors, etc., based on service lines, geographic areas, market areas, sites and/or times of services rendered, etc. Upon receiving the request, in some instances, the CD3A server 102 may obtain healthcare claim forms and/or claims data from a variety of sources for analysis so as to draw conclusions about a healthcare marketplace and its participants. For example, the server 102 may receive healthcare claim forms and/or claims data from the client device 101 itself. Other sources 103 of the claim forms and/or claims data comprise claims clearinghouses, electronic claims switches, payors, practice management vendors, revenue cycle management companies, electronic medical records/electronic health records (EMR/EHR), payor-specific claims, government claims, specialty adjudicators, and/or the like. In some instances, the CD3A server 102 may specify the geographic/market area and/or temporal range of the claims data sought for analysis. For example, the server 102 may request from the client device 101 and/or the sources 103 for claims data that are generated by physicians, providers, practices, etc., in a market area defined by zip codes, and/or any other mechanism for defining geographic areas (e.g., county, business district, hospital district, city lines, etc.). In some instances, the request for claims forms may specify the length of time that has passed and/or hasn't passed since the generation of the claims data and/or some chosen index event. For example, the server may request the claims data not be older than about 180 days, about 120 days, about 60 days, about 45 days, about 30 days, about 15 days, etc. As an example, the CD3A server 102 may issue PHP/SQL commands to query a database table (such as FIG. 6, Claims 619h) for health insurance claims. An example healthcare insurance claims query 105, substantially in the form of PHP/SQL commands, is provided below:

| | |
|---|---|
| 1 | <?PHP |
| 2 | header(‘Content-Type: text/plain’); |
| 3 | mysql_connect(“254.93.179.112”,$DBserver,$password); |
| | // access database server |
| 4 | mysql_select_db(“CD3A_DB.SQL”); // select database table |
| | to search |
| 5 | //create query |
| 1 | $query = “SELECT NYClaims NJHospitalDistrictClaims |
| | 90210Claims FROM |
| 2 | ClaimsTable WHERE claims LIKE, ‘%’ $45days”; |
| 3 | $result = mysql_query($query); // perform the search query |
| 4 | mysql_close(“CD3A_DB.SQL”); // close database access |
| 5 | ?> |

Upon receiving the healthcare insurance claims forms and/or claims data from the sources of claims data, e.g. 106, in some embodiments, the CD3A server 102 may proceed with extracting some or all the data from the received health insurance claims forms, e.g., 107. In some embodiments, some of these data may have already been extracted from the claims forms prior to arrival at the server 102, and the CD3A server 102 receives the extracted data. Upon receiving the claim forms for extraction, in some embodiments, the CD3A server 102 may proceed with pulling out a number of variables from the claims, including provider NPIs (Type 1 for individuals including physicians, dentists, sole proprietors, etc.) and organizational NPIs (Type 2 for providers with ‘Doing Business As’ (DBA) names, legal business names, etc.) assigned by the National Plan and Provider Enumeration System (NPPES), provider specialty taxonomy codes, submitted charges, patient birthdates, patients gender, payors, diagnosis, ICD and CPT codes, dates of service and/or the like. In some instances, the claim forms may list patient data, diagnoses, procedures performed, referring provider if the patient was referred by another provider, dates, location, sites of service, etc., of the healthcare service rendered, and/or the like, and some or all of these data may be extracted from the claims forms by the CD3A server 102. For example, the CD3A may extract ICD codes of the diagnoses listed on the claim forms including the primary diagnosis, CPT codes of the healthcare service provided including the category levels (e.g., category I, II, III, etc.), NPI of the provider, name and identifying information (such as an I.D. number, etc.) of referring provider, etc. An example listing of a claims analysis and data extraction 112, substantially in the form of a HTTP(S) POST message including XML-formatted data, is provided below:

| | |
|---|---|
| 6 | |
| 7 | |
| 8 | <?XML version = “1.0” encoding = “UTF-8”?> |
| 9 | <claims_form_extraction> |
| 10 | <session_ID>4NFU4RG94</session_ID> |
| 11 | <source_1>dr_johns_md</source_1> |
| 1 | <claim_form_type>cms1500</claim_form_type> |
| 2 | <claim_trnsm>electronic</claim_trnsm> |
| 3 | <claim_form_size>6pgs</claim_form_size > |
| 4 | <claim_insur_type> |
| 5 | <type>CHAMPVA</type> |
| 6 | <VAFile#>897af78a6</VAFile#> |
| 7 | </claim_insur_type> |
| 8 | <patient_info> |
| 9 | <patient_params> |
| 10 | <patient_id>123456789</patient_id> |
| 11 | <patient_name> John Smith </patient_name> |
| 12 | <address> 1 Piazza Square </address> |
| 13 | <city> Montego Bay </city> |
| 14 | <State> NY </State> |
| 15 | <patient_employ> Student </patient_employ> |
| 16 | ... |
| 17 | </patient_params> |
| 18 | <employer_info> |
| 19 | <employer_name>USA University</employer_name> |
| 20 | <employer_plan>BSBC Plan</employer_plan > |
| 21 | ... |
| 22 | </employer_info> |
| 23 | <health_histry> |
| 24 | <cndtn_rltd_1>auto accident</cndtn_rltd_1> |
| 25 | <cndtn_rltd_2>auto accident</cndtn_rltd_2> |
| 26 | ... |
| 27 | </health_histry> |
| 28 | </patient_info> |
| 29 | <provider_info> |
| 30 | <provider_params> |
| 31 | <provider_id>123456789</provider_id> |
| 32 | <provider_name> Carlos Mendez </provider_name> |
| 33 | <work_address> |
| 34 | <Street_address> |
| 35 | 3 Times Square |
| 36 | </Street_address> |
| 37 | <city> NYC </city> |
| 38 | <State> NY </State> |
| 39 | </work_address> |
| 40 | <billing_address> |
| 41 | <POBox> 1234 </POBox> |
| 42 | <city> NYC </city> |
| 1 | <State> NY </State> |
| 2 | </billing_address> |
| 3 | <service_facility>hospital</service_facility> |
| 4 | ... |
| 5 | </provider_params> |
| 6 | </provider_info> |
| 7 | <diagnosis_info> |
| 8 | <diagnosis_params> |
| 9 | <diag_dates>12-12-2046</diag_dates> |
| 10 | <diag_loc> Beth Israel Hospital </diag_loc> |
| 11 | <diag_type> ... </dia_type> |
| 12 | <diag_code> |
| 13 | <HCPCS_data> |
| 14 | <level>Level I</level> |
| 15 | <CPT_type>category 1</CPT type> |
| 16 | <CPT_code>26742</CPT_code> |
| 17 | </HCPCS_data> |
| 18 | <ICD_data> |
| 19 | <ICD_type> ICD9 </ICD> |
| 20 | <ICD_Code> 715.09 <ICD_code> |
| 21 | </ICD_data> |
| 22 | </diagnosis_params> |
| 23 | <referral_data> |
| 24 | <referral> TRUE </referral> |
| 25 | <referring_name>Mike Belton,MD</ referring_name> |
| 26 | <referring_ID>15673375<referring_ID> |
| 27 | <referring_NPI>NA<referring_NPI> |
| 28 | <referring_affiliation>NA<referring_affiliation> |
| 29 | <referring_address> |
| 30 | <Street> 6th St </Street> |
| 31 | <city> NYC </city> |
| 32 | <State> NY </State> |
| 33 | </referring_address> |
| 34 | </referral_data> |
| 35 | </diagnosis_info> |
| 36 | ... |
| 37 | </claim_insur_type> |
| 38 | <claims_form_extraction> |
| 39 | |
| 40 | |

To satisfy HIPAA restrictions, claims may be de-identified to anonymize patients and mask other personal information. For example, the claims data may be manipulated so that only the first three digits of a patient's zip code become available for analysis. The claims may also be assigned a unique identification number so patient transit across multiple providers and/or sites of service can be used for referral analytics. For example, some physicians may practice at several hospitals in addition to running their own practices, and hence the data may show several affiliations for the physicians (also multiple specialties and/or sub-specialties). As such, the use of a unique identification number for a patient allows for the proper construction of at least a portion of the healthcare history of the patient. For instance, in constructing a referral history of a patient, the interpretation of data showing the patient's visit from one practice to another as a referral may depend on whether the patient is visiting same physician or not at the second location.

In some embodiments, the CD3A server 102 may utilize information provided by the client device to interpret the extracted data in view of the client's request for healthcare marketplace information and/or intelligence. For example, the client device may provide information (e.g., along with or separately from the request, e.g., 104, for healthcare marketplace information) such as the client's definition of a geographic market area. In some instances, the market area, which may be defined at the zip code level, may be further broken down by primary, secondary, tertiary, so forth areas. Other examples of such information are definitions of service lines, sub-service lines, and corresponding DRG, CPT and/or ICD codes, payors in the market areas, names and/or NPIs of facilities/sites of service aligned with the client, names and NPIs of other providers in or outside the market area (e.g., providers that are competitors to the client, etc.), information on providers associated with client such as medical specialty, employment status, etc., (e.g., from client's credentialing and/or physician rosters, etc.), and/or client's patient discharge/revenue cycle information (e.g., full year, quarter year, etc.). Such definitions and/or information allow the CD3A server 102 to interpret and/or customize the extracted data with respect to the client. For example, based on the information/definitions, in some instances, the server 102 may map the extracted claims data in the client's market area according to the client's service lines and sub-service lines. In some embodiments, the CD3A server 102 may utilize default settings to interpret the extracted data for a client.

In some embodiments, the CD3A server 102 may receive additional input from other sources to interpret the extracted data. For example, the server may obtain data on physicians, providers, practices, etc., that may or may not be affiliated with the client from other sources such as third party vendors, and perform a detailed analysis on the claims data to correlate the extracted information with the additional input from external sources. For example, using these inputs, the CD3A server 102 may identify the diagnostic related groups (DRG) of the claim, provider specialties, practice affiliations of the providers listed on the claims, etc. As an example, by analyzing the extracted claims data in view of additional input, the server 102 may determine the DRG value of a claim form, for instance by utilizing health data processing engines (e.g., Health Language, Inc.'s Lex engine, etc.) to assess and assign relative weights to data points extracted off of claim forms. For example, if a claim shows a patient has a primary diagnosis of heart failure, a logic algorithm may consider the relative weight assigned to this data point with respect to other data points extracted from the claims form and obtained from external sources (e.g., the specialty of a referred physician that is not part of the client's network of physicians) to assign a DRG value indicating a cardiological diagnosis related group for the claim.

In some embodiments, by utilizing provider affiliations, the CD3A server 102 may determine referral patterns amongst providers. For example, if data from an extracted claim form shows that a provider in a client's network referred a patient to another provider in the client's network, the server may identify that as an “in-network” referral, in contrast to referrals to providers outside of client's network, so called “out-of-network” referrals. Such information allows the server 102 to recognize patterns and/or insights that may not be apparent in the raw claims data, such as but not limited to a client's market leakage, the referrals that are made to providers who are not ‘in-network’ and care that is provided to patients in sites of service that are not ‘in-network’. As another example, the CD3A server 102 may utilize such information to obtain more details on the marketplace participants. For example, the CD3A may utilize the provider information extracted from the claims form, such as the provider's name and address, to retrieve the provider's NPI, specialties, affiliations, etc., leading the CD3A 102 to discover, for example, that the provider is board certified orthopedic physician currently running a private practice as well as practicing at two different hospitals, which may or may not be aligned with a client's network. Further analysis may provide a detailed view of the activities of such providers, broken down or grouped by service lines, specialties, sites of service, types of payors (e.g., commercial, government, etc.) to the provider. Other examples of the activities comprise referral patterns including the number of referrals, providers and/or practices referrals are made to, the value of the referrals, etc. Analyses broken down by several variables may also be performed for practices, payors, service lines, etc. For example, for service lines, the analysis may reveal the practices a service line is referred to (e.g., cardiac referrals usually go to hospital A, cancer referrals to hospital B, etc.), the proportions of payouts based on payor types (e.g., cancer procedures are mostly paid by commercial payors, etc.), and/or the like).

In some embodiments, the CD3A server 102 may verify that some or all the connections between providers along a patient's longitudinal healthcare pathway may be considered as referrals, i.e., the connections have high fidelity to characteristics of a referral relationship. For example, in some instances, routine patient visits for diagnostic imaging, physical therapy, etc., may not be considered as referrals, and the server 102 may utilize such criteria to filter out visits. Another example of a criterion may be that physician referrals within the same practice may not be considered as a referral relationship. Filtering out of such provider/practice visits that fail to meet the criteria for being deemed as a referral relationship takes into account reality-based physician-to-physician referral patterns, leaving behind a longitudinal healthcare pathway that in fact may be considered as a longitudinal referral record of the patient, and may lower the risks of overestimating the number of referrals in a patient's referral record.

In some instances, the CD3A server 102 may employ a filtering algorithm that is based on the foundation of service lines and sub-service lines to verify provider/practice visits along a patient's longitudinal healthcare pathway as referrals. Service lines and sub-service lines may have their own set of unique interaction rules that take into account actual referral patterns among specific medical specialties. For example, the filtering algorithm may utilize a set of unique interaction rules that specify acceptable referral patterns among medical specialties, i.e., which provider specialties can generate referrals and which specialties can receive these referrals (e.g., which medical specialties are most likely, least likely, etc., to refer and/or receive some types of referrals). For example, the algorithm may label a patient's visit from PCP to an OB/GYN as a likely case of a referral relationship, in contrast to a patient's visit from a podiatrist to a cardiologist as unlikely. In some instances, the algorithm may assign weight factors to such scenarios and make a determination of referral relationships partly based on a calculation of the likelihood of such weighted scenarios. In some embodiments, the algorithm may also consider the particular order of visits in the patient's pathway in evaluating whether the visits can be considered as referrals. For example, a healthcare pathway comprising visits from, for example, PCP, emergency physician, or OB/GYN to a medical cardiologist may have an acceptable order, i.e., ‘referral hierarchy’, and such visits may be considered as a referral relationship.

In some instances, a single or very few visits in a patient's longitudinal healthcare pathway may fail to qualify as referral relationships. For example, in the above scenario, the patient may have initially visited a PCP, then medical cardiologist, then a physical therapist, and finally a cardiothoracic surgeon sub-specialist. In such embodiments, the algorithm may utilize “leave-out” criteria to remove the physical therapist from the chain so as to reduce such ‘noise’ that may mask accurate referral relationship between, for example, the medical cardiologist and the cardiothoracic surgeon. In other words, the visits from the medical cardiologist to the physical therapist and from the physical therapist to the cardiothoracic surgeon may not be considered as referral relationships based on the criterion that a visit to/from a physical therapist may not be labelled as such. However, in this example, the leave out criterion allows the algorithm to correctly identify the visits to the medical cardiologist and then to the cardiothoracic surgeon as a legitimate referral relationship. Further, in some embodiments data from extracted claims may not represent a complete patient encounter history, and the algorithm may assign an index event and a look-back period to trace patient encounters and referral hierarchy in the patient's healthcare pathway history. For example, a look back period of 180 days from an index event may provide sufficient time to accurately capture referral activity, even with providers with medical specialties that may be more difficult to get appointments with in a timely manner.

Upon establishing patient referral records, in some embodiments, the CD3A server 102 may aggregate the patient referral records to analyze and characterize, amongst other things, network behavior. For example, by considering patient referral records, the server 102 may utilize index event pattern recognition analysis to determine provider, practice, service line, payor, etc., referral patterns for some market area and time frame, e.g., 108. For example, the CD3A server 102 may discover that a physician refers all her/his patients with a heart problem to hospital A for specialized attention, while patients with liver issues are sent to hospital B. Based on the alignments of providers, practices, service sites, etc., with a client, the CD3A server may thus be able to determine if the referrals are “in network” or not, thereby obtaining a measure of a provider and/or practice's loyalty to a client. In some implementations, the CD3A server 102 may be able to retrieve from a plurality of patient referral records networks of referral based on service sites, service lines, payors, etc. For example, an amalgamated analysis of a plurality of referrals may reveal which service line receives payments from which type of payor (e.g., largest portion of commercial payments in a market area is devoted to cardiothoracic surgeries at service site A, cancer referrals usually flow to university hospital B, etc.). Further, by aggregating and ranking most or all referrals for a service line (e.g., cancer diagnosis) in a market area based on provider, practice, payor, etc., in some instances, the server may establish the most influential providers in the market area. For example, the analysis may reveal data such as, but not limited to, the providers and/or practices that are referring the most number/volume of referrals, the highest number of high value referrals, the providers and/or practices with the most number of referred providers/practices, etc. Such results may allow the server 102 and/or the client device 101 to draw conclusions on the influence level of a provider/practice in the market area. An example listing of a pattern recognition 108 function that takes in data from the claim forms as inputs to determine a provider's network chart is provided below:

| | |
|---|---|
| 1 | public with sharing class ProviderNetworkChart { |
| 2 | public boolean fail{get;set;} |
| 3 | public String centerNode{get; set;} |
| 4 | public String nodes{get;set;} |
| 5 | public String jsonString{get; set;} |
| 6 | public Integer nodeCount{get; set;} |
| 7 | |
| 8 | public String sfid{ |
| 9 | get{ |
| 10 | if(sfid == null && ApexPages.currentPage( ).getParameters( ).get(‘ |
| 11 | sfid’) != null) return ApexPages.currentPage( ).getParameters( ).get(‘sfid’); |
| 12 | else return null; |
| 13 | } |
| 14 | |
| 15 | private set; |
| 16 | } |
| 17 | |
| 18 | public String dir{ |
| 19 | get{ |
| 20 | if(dir == null && ApexPages.currentPage( ).getParameters( ).get(‘dir |
| 21 | ’) != null) return ApexPages.currentPage( ).getParameters( ).get(dir’) ; |
| 22 | else return null; |
| 23 | } |
| 24 | |
| 25 | private set; |
| 26 | } |
| 27 | |
| 28 | public Contact center{ |
| 29 | get{ |
| 30 | if(center == null && sfid != null && dir != null){ |
| 31 | center = [Select c.Title, c.Name, c.LastName, c.HC4_Primary |
| 32 | Specialty_r.Name, c.HC4_PrimarySpecialty_c, c.FirstName From Contact c WHERE |
| 33 | c.Id =: sfid LIMIT 1]; |
| 34 | centerNode = center.FirstName + ‘ ’ + center.LastName; |
| 35 | return center; |
| 36 | }else return center; |
| 37 | } |
| 38 | |
| 39 | private set; |
| 40 | } |
| 41 | |
| 42 | public list <ProviderNetwork_c> ins{ |
| 1 | get{ |
| 2 | if(ins == null && sfid != null && dir != null){ |
| 3 | ins = [SELECT p.GeneratingProviderScore_r.HC4_ServiceLine_{—} |
| 4 | _r.HC4_Subgroup_c, |
| 5 | p.GeneratingProviderScore_r.HC4_ServiceLine_{—} |
| 6 | r.Id, |
| 7 | p.GeneratingProviderScore_r.HC4_ServiceLine_{—} |
| 8 | r.Name, p.GeneratingProviderScore_r.HC4_ServiceLine_c, |
| 9 | p.GeneratingProviderScore_r.HC4_Provider_r.HC4 |
| 10 | _NPI_c, p.GeneratingProviderScore_r.HC4_Provider_r.Name, |
| 11 | p.GeneratingProviderScore_r.HC4_Provider_r.First |
| 12 | Name, p.GeneratingProviderScore_r.HC4_Provider_r.LastName, |
| 13 | p.GeneratingProviderScore_r.HC4_Provider_c, |
| 14 | p.GeneratingProviderScore_r.HC4_Provider_r.HC4 |
| 15 | _PrimarySpecialty_r.Name, |
| 16 | p.ReferringPracticeGroup_c, p.ReferralCount_c |
| 17 | , |
| 18 | p.ReceivingProviderScore_r.HC4_Provider_r.HC4 |
| 19 | _NPI_c, p.ReceivingProviderScore_r.HC4_Provider_r.FirstName, |
| 20 | p.ReceivingProviderScore_r.HC4_Provider_r.Last |
| 21 | Name, ReceivingProviderScore_r.HC4_Provider_c, |
| 22 | p.ReceivingProviderScore_r.HC4_Provider_r.HC4 |
| 23 | _PrimarySpecialty_r.Name |
| 24 | From ProviderNetwork_c p WHERE |
| 25 | p.ReceivingProviderScore_r.HC4_Provider_c =: sfid]; |
| 26 | return ins; |
| 27 | }else return ins; |
| 28 | } |
| 29 | private set; |
| 30 | } |
| 31 | |
| 32 | public list <ProviderNetwork_c> outs{ |
| 33 | get{ |
| 34 | if(outs == null && sfid != null && dir != null){ |
| 35 | outs = [Select p.GeneratingProviderScore_r.HC4_ServiceLine |
| 36 | _r.HC4_Subgroup_c, p.GeneratingProviderScore_r.HC4_ServiceLine_r.Name, p. |
| 37 | GeneratingProviderScore_r.HC4_ServiceLine_c, |
| 38 | p.ReceivingProviderScore_r.HC4_Provider_r. |
| 39 | HC4_NPI_c, |
| 40 | p.ReceivingProviderScore_r.HC4_Provider_c, |
| 41 | |
| 42 | p.ReceivingProviderScore_r.HC4_Provider_r. |
| 1 | FirstName, |
| 2 | p.ReceivingProviderScore_r.HC4_Provider_r. |
| 3 | LastName, |
| 4 | p.ReceivingProviderScore_r.HC4_Provider_r. |
| 5 | HC4_PrimarySpecialty_r.Name, |
| 6 | p.ReferringPracticeGroup_c, p.ReferralCount_{—} |
| 7 | _c, |
| 8 | p.GeneratingProviderScore_r.HC4_Provider_r |
| 9 | .HC4_NPI_c, |
| 10 | p.GeneratingProviderScore_r.HC4_Provider_r |
| 11 | .FirstName, |
| 12 | p.GeneratingProviderScore_r.HC4_Provider_r |
| 13 | .LastName, |
| 14 | p.GeneratingProviderScore_r.HC4_Provider_c |
| 15 | , |
| 16 | p.GeneratingProviderScore_r.HC4_Provider_r |
| 17 | .HC4_PrimarySpecialty_r.Name |
| 18 | From ProviderNetwork_c p WHERE p.GeneratingProvid |
| 19 | erScore_r.HC4_Provider_c =: sfid]; |
| 20 | return outs; |
| 21 | }else return outs; |
| 22 | } |
| 23 | private set; |
| 24 | } |
| 25 | |
| 26 | |

From the analysis of a single and/or plurality of patient referral records, in some embodiments, the CD3A server 102 may produce and present to the requesting client device 101 actionable intelligence on the state of a healthcare marketplace and/or its participants, e.g., 109. Some or all of the intelligence may be directed to individual and/or to network of providers, practices, service lines, payors, etc. For example, from the proportion of a market area's service and sub-service line referrals that are in a client's network versus out-of-network, the CD3A server 102 may establish the source, amount, destination, etc., of a client's market leakage, allowing a client with such intelligence to devise campaigns/plans to address such issues. Such campaigns comprise the involvement of physician liasons to engage in outreach with the sources (e.g., providers and/or practices) of leakage to reduce the leakage. In some instances, analysis results after a liason's interaction with sources of leaks may be used as measures of the liason's performance, an evaluation of the efficiency of the particular outreach campaign, and/or the willingness of the target provider to respond positively to the outreach, thereby allowing the client/liason to deploy resources appropriately. The intelligence may also provide granular information on providers/practices, such as but not limited to identities of physicians referring specific procedures, a practice's contribution to a particular service or sub service line, value of a PCP referral to a specialist, identities of providers of choice among referring physicians, and/or the like. In some instances, the intelligence on some providers may be used by a client to make strategic planning/decisions, such as but not limited to deciding which providers to acquire in which service and/or sub-service lines (e.g., the most influential referring providers as determined by the number and/or value of their referrals), identifying and reacting to the practices from which most referrals come from and/or the providers/practices most referrals are directed to, etc. Other examples of uses of obtained intelligence comprise guidance on selecting geographic location for new practices/service sites, identifying primary competition for service and subservice lines in a specific geographic area, estimating size of the medical market, determining volume of activities of the specialists in a multi-specialty group, and/or the like.

To facilitate the presentataion and/or visualization of the healthcare marketplace intelligence, in some implementations, the CD3A server 102 may offer scores indicating referral loyalty level and/or referral volume of a provider in a market area and/or in a service line to the client. For example, a co-dynamic score may be calculated for each physician based on their referral volume, as well as referrals generated from that physician to the client (e.g., providers and/or practices within the client network). A particular implementation of such scoring comprises a score ranging from A to E for volume in decreasing amount, and a score ranging from 1 to 5 for loyalty, 1 indicating highest loyalty. As such, a score of A5 indicates a provider with highest volume of referrals but lowest loyalty. Such scoring mechanism is a highly useful in identifying and visualizing opportunities and trends in the healthcare marketplace. For example, co-dynamic scores for providers may trigger a client to divert outreach resources to where the outreach may have the highest return (e.g., no need to engage providers with A1 or E5 as much as providers with a score of A or B for volume and 3, 4 or 5 for loyalty, etc.). Such scoring may be service line and market area dependent. For example, X number of referrals in Market Area 1 may earn a provider a volume score of A, while in Market B same number only results in a score of B. Similarly, a physician with an orthopedic referral co-dynamic score of A1 may have a score of A4 for cardio cases. Such a scoring system allows clients to visually understand the ranges of a provider's volume, loyalty, influence, etc., in the market area and direct outreach efforts accordingly. It is to be understood that the disclosure of the above method of scoring using letters and numbers is for illustration purposes, and is not intended to limit ways of quantifying the various variables such as loyalty, volume, influence, etc.

FIG. 2 shows an example logic flow illustrating aspects of claims data extraction, in one embodiment. At step 201, the CD3A server 102 receives health insurance claim forms from one or more sources of the forms. For example, the forms may be the HIPPA compliant standard health insurance claim form CMS-1500. At step 202, the server reviews the received claim forms for completeness to verify the forms include at least some data for identification of the provider (e.g., NPI, etc.), e.g., 203. In some instances, one or more claim forms may not contain such data, and may be logged as incomplete, e.g., 211. For the claim forms with sufficient data for analysis, at step 204, the CD3A server 102 may assign unique identification numbers and anonymize the claim forms so as not to allow the tracking of individual patients from the claim forms. At step 205, the server may identify providers/practices on the extracted claims data by, for example, querying a provider database using physician and/or provider NPIs, e.g., 206. In some instances, the CD3A server 102 may also obtain claims forms and/or data extracted from claims forms from clearinghouses, electronic claims switches, payors, practice management vendors, revenue cycle management companies, electronic medical records/electronic health records (EMR/EHR), payor-specific claims, government claims, specialty adjudicators, and/or the like. Upon receiving the information on providers and/or practices at step 207, the CD3A server 102 may retrieve information on providers, practices, service lines, payors, etc. from the received healthcare provider/practice data, e.g., 208 as has been described above. For example, to establish affinity of providers to practices, service sites, clients (e.g., health organizations, etc.), at step 209, the server 102 may also interrogate external data sources (e.g., if the affiliation of the provider is not determined from information provided by the client), e.g., 210. In some instances, the server may not be able to establish the affiliation of the providers, and such data claims, as identified by their unique identifiers may be logged as “undetermined-affinity”, e.g., 212. For claims with affinity information available, at step 213, the server may determine if the providers belong to the client's network of providers, e.g., 214, or if they are out of the network providers, e.g., 215. In some instances, at step 216, the CD3A server 102 may also check if the provider is a PCP, as PCPs contribute significantly to referral hierarchies. Examples of medical specialties that may be classified as primary care comprise internal medicine, family medicine, family practice, general medicine, pediatrics, geriatrics, adolescent medicine, etc., e.g., 218. In some instances, the provider may not be a PCP, and the server 102 may then determine the specialties of the provider, e.g., 217.

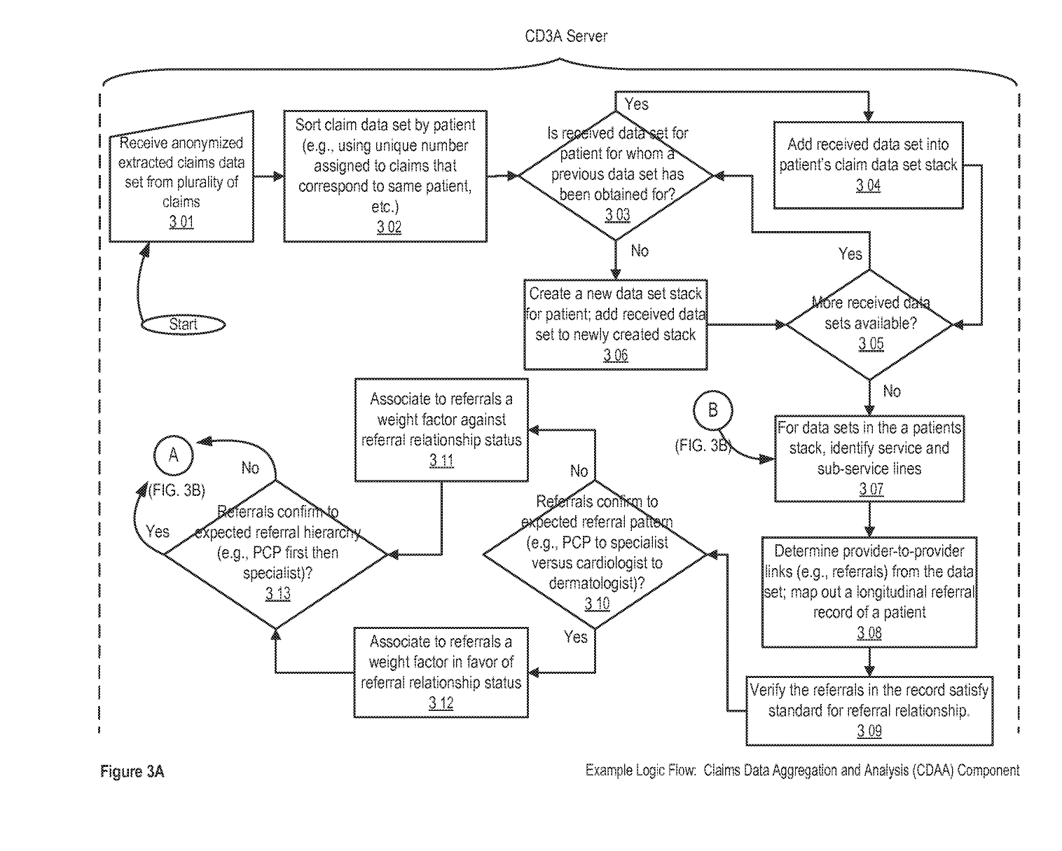

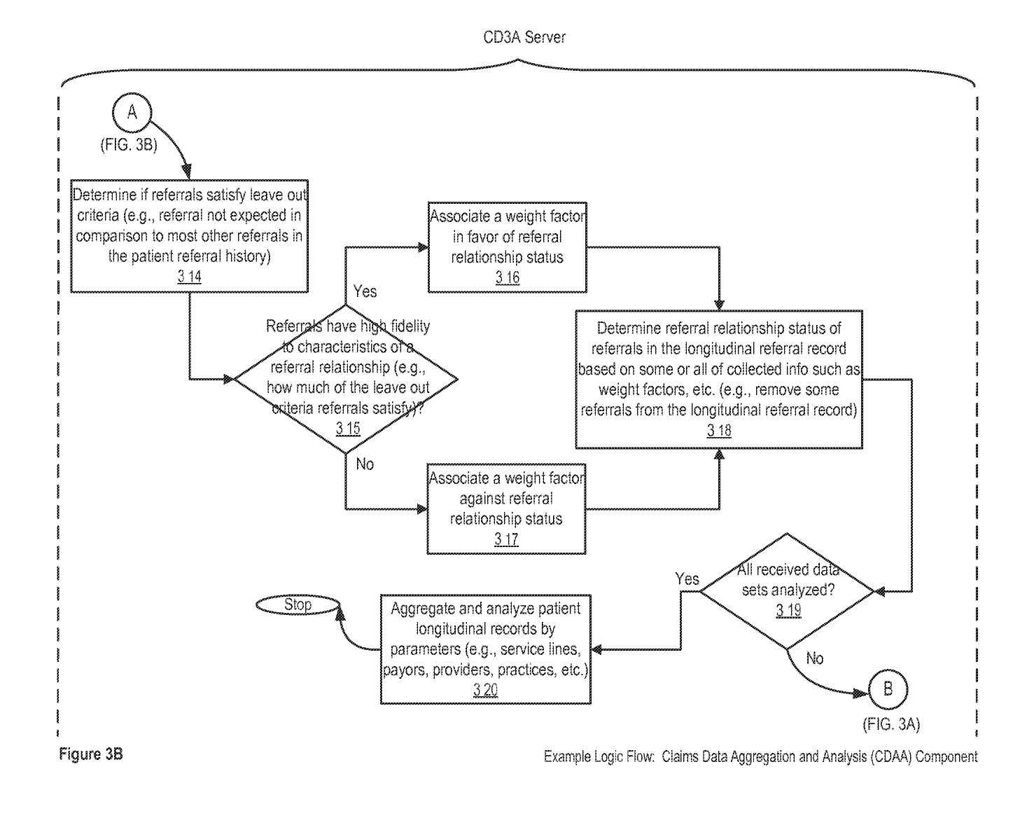

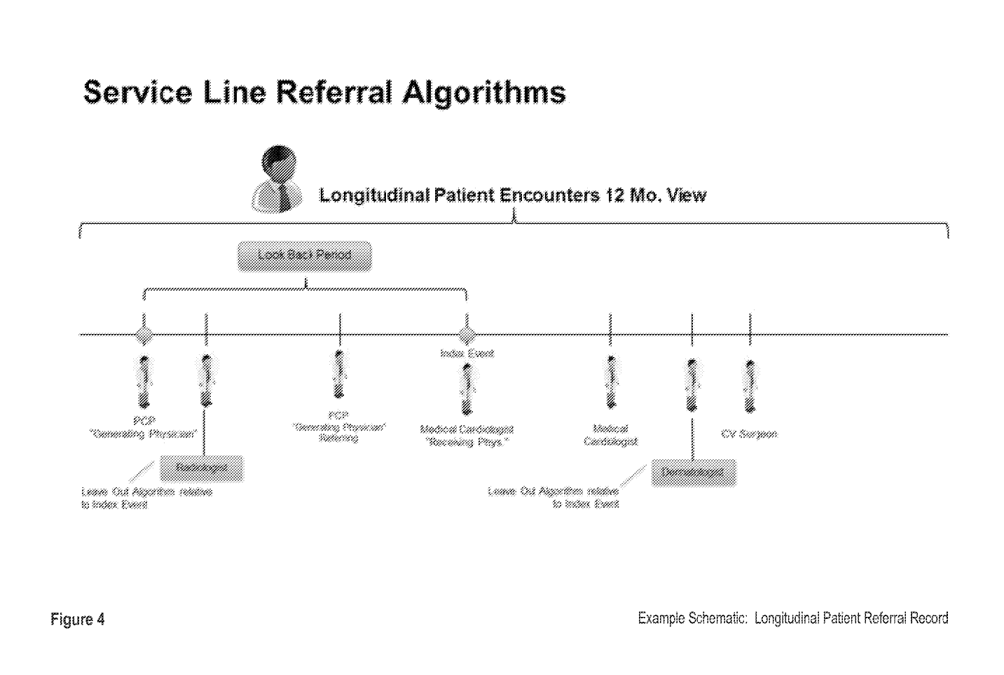

FIGS. 3A-B shows an example logic flow illustrating aspects of claims data aggregation and analysis, in one embodiment. At step 301, the CD3A server 102 receives anonymized extracted claims data from a plurality of claim forms for analysis to produce intelligence on the state of the healthcare marketplace. Using the unique identification numbers assigned to claims that correspond to same patient, at step 302, the CD3A server 102 may sort the received claim data set according to patients. The CD3A server 102 may either create a stack if the received data set is for a patient no data has been received for, e.g., 306, or it may add the data set to an existing stack of claims data corresponding to the patient with the unique identification number, e.g., 304. The server may proceed with the sorting process, e.g., 303, until all the received claims data have been sorted according to patient identification numbers, e.g., 305. Upon sorting all received data sets, in some instances, the server 102 may proceed with analyzing the data sets for each patient with the view of constructing a longitudinal healthcare pathway for each patient. For example, the server 102 may determine the service and subservice lines of the received claims data at step 307. When constructing the longitudinal healthcare pathway at step 308, the server 102 may verify all links or connection between patient visits to various providers satisfy the criteria for consideration as a referral relationship, e.g., 309. An example of these criteria is determining if the provider to provider visits confirm to expectations of referral patterns, e.g., 310. For example, a visit from a PCP to a specialist may pass as a referral relationship, while a visit from cardiologist to a dermatologist may cause further analysis. In some instances, the server may assign weight factors in favor of, e.g., 312, or against, e.g., 311, designation of provider visits as referral relationship. Another example of criteria is the determination if the provider visits follow an expected hierarchy for a referral relationship, e.g., 313. For example, a provider visit to a PCP first and then a specialist may qualify as a referral relationship, while in the reverse order may not. In such instances, the CD3A server 102 may assign weight factors in favor of, e.g., 316, and against, e.g., 317, respectively, the designation of provider visits as referral relationships. In some instances, a longitudinal pathway of a patient may include provider visits that may qualify as referral relationships interspersed with visits that fail to do so. For example, a pathway such as PCP to diagnostic imaging facilty to cardiologist may involve visits that may be considered as non-referral relationships (e.g., the visit from PCP to diagnostic imaging facilty and the visit from diagnostic imaging facilty to the cardiologist). However, the visit from the PCP to the cardiologist, which may be considered as a referral relationship, may be masked by the presence of the diagnostic imaging facilty visit in the longitudinal pathway. In some instances, the CD3A server 102 may subject such pathways to leave-out criteria, e.g., 316, so as to remove the non-referral relationsip visits (e.g., the diagnostic imaging facilty visit) from the pathways and arrive at longitudinal referral records comprising referral relationships, e.g., 317. FIG. 4 shows a schematic illustration of a patient's longitudinal healthcare pathway for a look back period the length of which is configured to capture most or all provider visits relevant for constructing a patient longitudinal referral record, and provider visits that may be removed from the pathway for failure to meet a leave out criteria.

In some implementations, at step 318, the server 102 may proceed with analyzing the received claims data as discussed above, and produce an intelligence output on the healthcare marketplace of the market area and its participants for use by the client, e.g., 319. The intelligence output may be presented in a customizable, interactive and visual/pictorial manner that allows for a meaningful understanding of the underlying plethora of healthcare data in a compact and digestible format. For instance, in presenting the output visualiazation tools may be used to display dashboards containing various elements that facilitate a client's interaction with the dashboard. For example, sheet tabs may be used to provide access to related information (e.g., from a “macro” view of information on service line showing referrals directed to in-network versus out-of-network providers to a detailed “micro” view showing the proportions going to each provider). Further, granular details such as specific service line(s), time periods, market areas, patient counts, procedure counts, claims total values, etc., may also be presented in the dashboard. In some instances, market areas may be displayed in maps with zooming capabilities, the zooming delivering a wide range of granularity in presenting the data (e.g., zooming in/out may show referrals numbers by zip codes, by neighborhoods, by counties, by states, etc.). Further client interaction with the dashboard is facilitated by abilities to highlight sections in the dashboard, as well as by capabilities such as links and document export options.

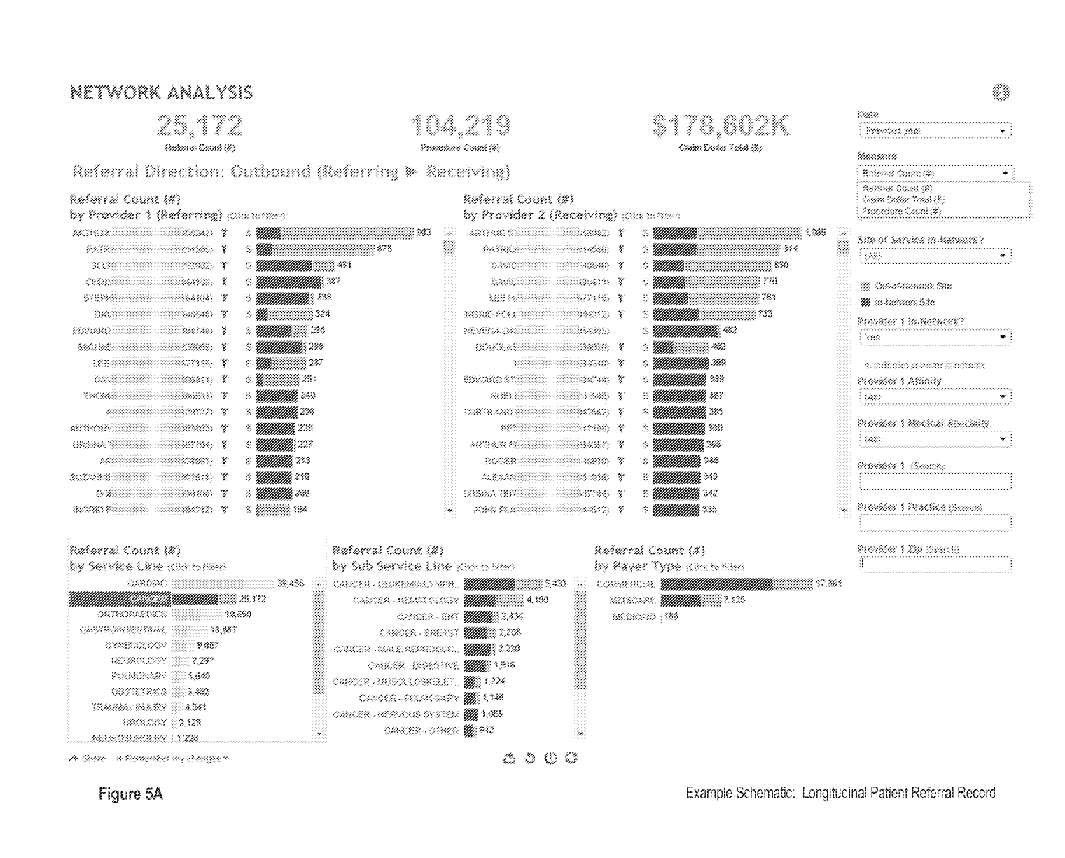

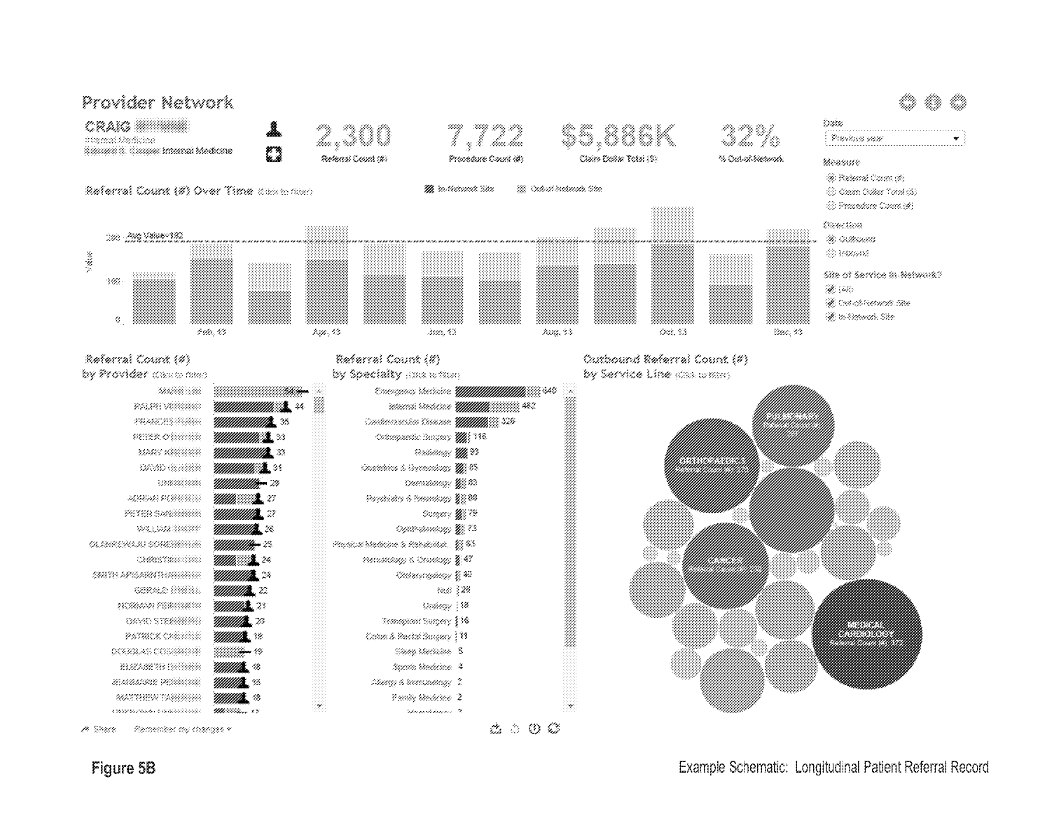

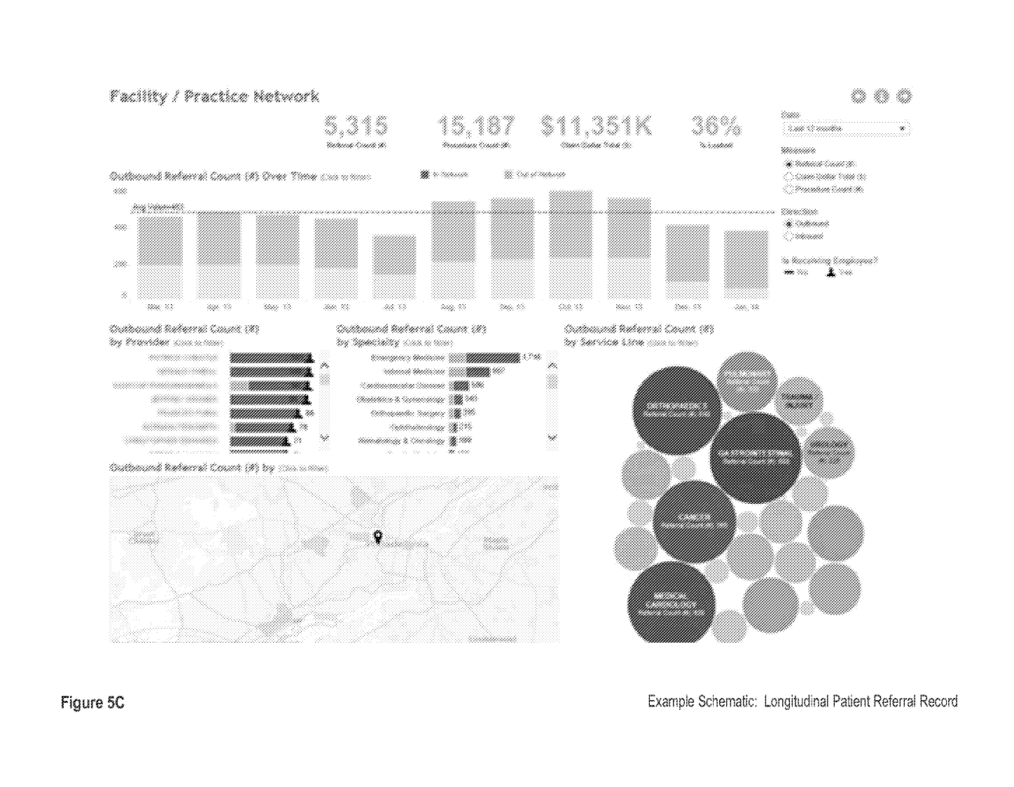

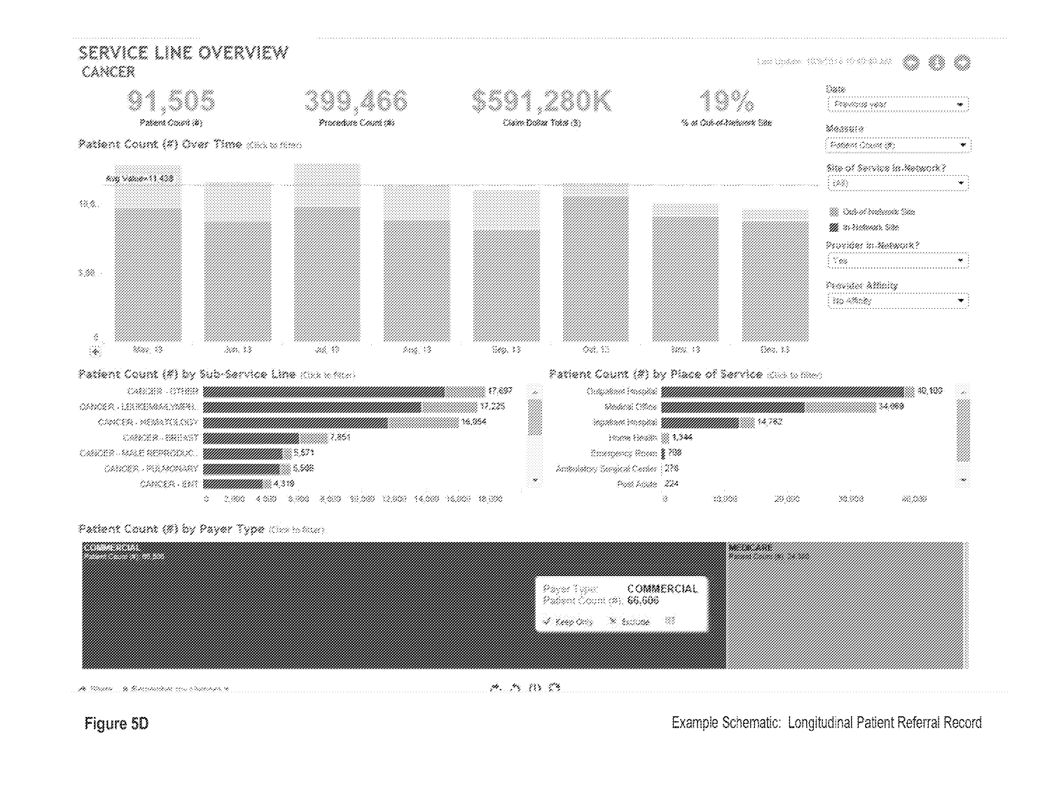

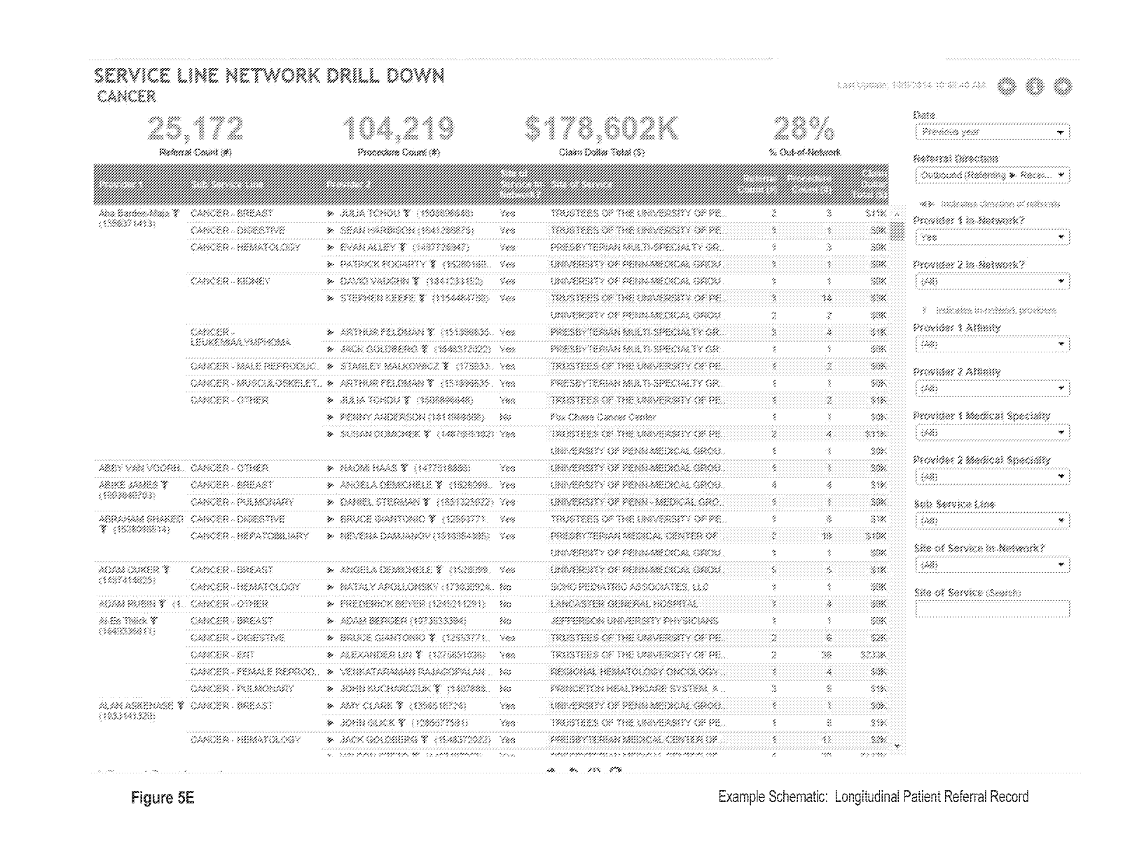

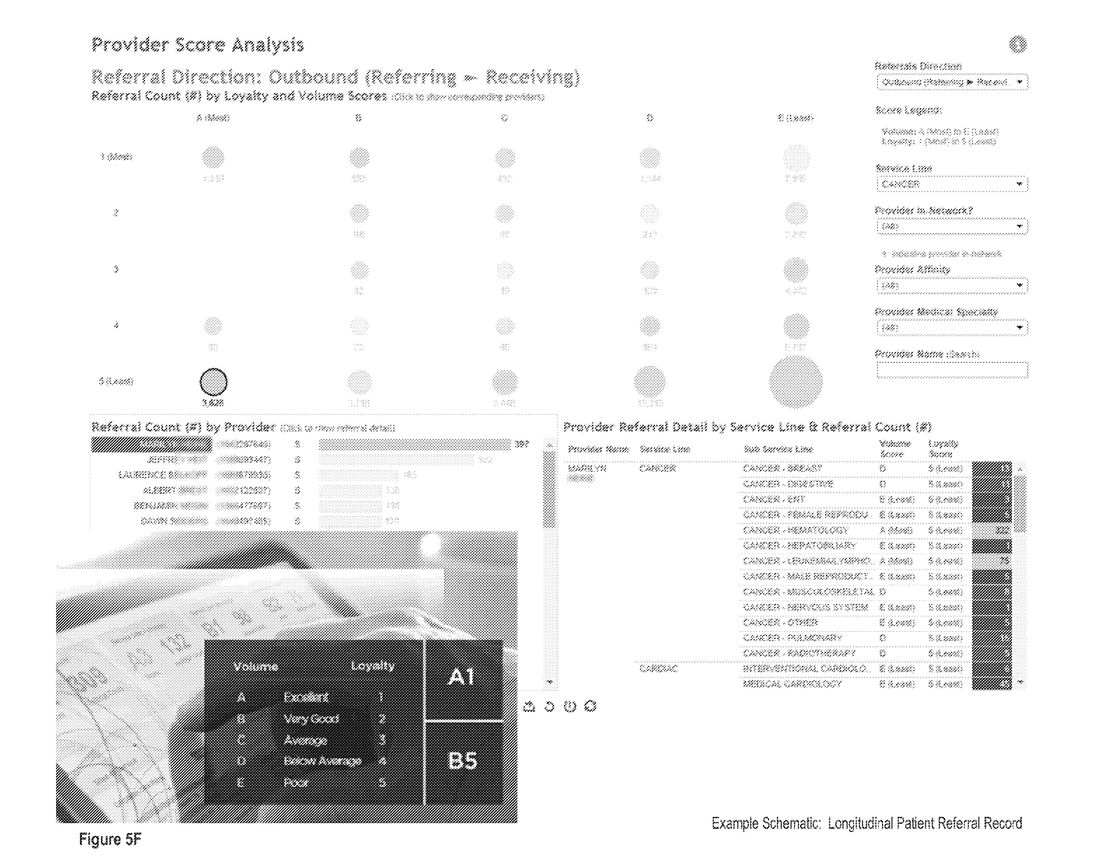

FIGS. 5A-G show example user interface (UI) screenshots illustrating analysis outputs of CD3A on the state of a healthcare marketplace and/or its participants. For example, FIG. 5A shows an illustration of exemplary results of network analysis of extracted claims data including inbound and outbound referrals with respect to a client and other sources of patient and market information including but not limited to provider patient data, licensed market data, etc. In some embodiments, the CD3A allows for the processing of the extracted claims data set of a network of providers (e.g., physicians practicing in a geographic area defined by, for example, zip codes) to obtain detailed information on the relationship of the providers to each other, and/or detailed information on the providers themselves. For example, the analysis may reveal referral data such as the total number of referrals in the claims data set, the number and/or the value of diagnoses and/or procedures performed as a result of the referrals, directions and destinations of the referrals (e.g., from provider/practice A to provider/practice B, etc.), and/or the like. In some instances, such referral data may be broken down or grouped by different parameters. These parameters may be service lines, sub service lines, payor types, in or out of network status of the receiving provider/practice, etc. For example, the analyzed referral data may show the count of referrals from a provider in one provider network that are referred to providers/practices that are in and outside the same provider network, yielding a measure of loyalty of the provider to the provider network. Similarly, the analyzed referral data may also show the loyalty of the provider based on comparison of the value of in network referrals to out of network ones. In some instances, the referral data may be broken down by service lines (e.g., cardiac, cancer, orthopedics, etc.), and further by subservice lines such as leukemia, hematology, breast cancer, etc., corresponding to the service line cancer etc. In some instances, the referral data may be classified based on the type of payor for the diagnosis and/or procedures that follow the referrals. Examples of payor types are commercial (e.g., health insurance companies, etc.), government agencies (Medicare, Medicaid, etc.).

FIG. 5B shows an illustration of exemplary results of provider network analysis of extracted claims data for a selected market area. In some embodiments, from the extracted claims data and/or an amalgamation of patient referral records, the CD3A may retrieve some or all the referrals that may have been made by the provider to be analyzed. The retrieved data may provide pieces of information on the provider's activities, such as the number of referrals and diagnoses/procedures in the selected time frame, total volume and/or value of the referrals directed at in-network versus out-of-network provider (e.g., a client's network), etc. For example, the analysis may reveal an ordered listing of providers that received referrals from the provider whose activities are analyzed. Further, this information may show whether the diagnosis and/or procedures resulting from the referral were performed at a service site that is aligned with the client's network. A similar analysis may be performed for service and sub-service lines that rank the service and sub-service lines for which referrals were made for. The presentation and visualization of such information as displayed in the sample UI of FIG. 5B allows the client to gauge the volume, loyalty and/or influence of a provider in their market area, and accordingly better tailor their outreach and/or planning activities to better achieve their goals. In some implementations, the CD3A may present these and other information over the selected time frame, providing a temporal view of the activities of the referring provider, such activities comprising referrals by service and sub-service lines, in-network referrals, out-of-network referrals, etc.

FIG. 5C shows an illustration of exemplary results of an analysis performed on extracted claims data similar to those described above with reference to FIG. 5B, but for practice/facility networks instead of provider network. In such embodiments, network refers to the network of providers, practices, etc., that are aligned with a client that has requested for the results of the analysis. In some embodiments, the CD3A allows for the processing of the extracted claims, patient, and market data to determine inbound or outbound referral counts by facilities and practice locations to obtain detailed information on the relationship of the facilities and practices by the types of procedures, specialties, types of referrals, and service line. For example, the analysis may reveal data such as the number of outbound referrals by a particular specialty at a particular location, by various service lines, by geography and the payor type (e.g. PPO or Medicaid), and/or the like. In some instances, the facility and practice data may be broken down or grouped by different parameters. These parameters may be inbound or outbound referrals, service or sub service lines, payor types, in or out of network status, dates of service, whether the referral is made by an employee or not, etc. For example, the analyzed claims data may show the count of outbound referrals by location and specialty, yielding a measure of patient counts for particular service lines by in network providers. Similarly, the analyzed referral data may also show how many claims are from a particular site within a market area. In some instances, the referral data may be classified based on the service or sub service line or other variables surfaced through the claims analysis.

FIG. 5D shows an illustration of exemplary results of an analysis of claims data based on service lines (e.g., cancer). In some embodiments, the CD3A provides information including patient counts, claims counts, dollars amounts and number of in and out of network sites (place of service) used for various medical service lines (e.g. orthopedic, OB/GYN, or cancer) and allows for the processing of the extracted claims and patient data set for particular service lines (e.g., oncology, orthopedics, etc.), and subservice lines (e.g. breast cancer, prostate cancer, etc.) to obtain detailed information on the relationship of the service lines to patient claims, sites of service, dates of service and referrals, types of referrals, and detailed information on payor mix. For example, the analysis may reveal data such as the total number of service and subservice line referrals in the claims data set, the number and/or the value of service and subservice line referrals, the sites of service for various service lines, and the payor type of various service and sub service lines (e.g. commercial or government), and/or the like. In some instances, such service line data may be broken down or grouped by different parameters. These parameters may be dates of service, sub service lines, payor types, in or out of network status, location of service, etc. For example, the analyzed claims data may show the count of service line and subservice line clams by location, yielding a measure of patient counts by place of service. Similarly, the analyzed service and subservice line data may also show how many claims are from in and out of network providers. In some instances, the service line data may be broken down by sub service lines (e.g., cancer broken down further by subservice lines such as leukemia, hematology, breast cancer, etc.) and segmenting by location of service, provider affinity, and the like. In some instances, the service line data may be classified based on the type of payor for the service or sub service line. Examples of payor types are commercial (e.g., health insurance companies, etc.), government agencies (Medicare, Medicaid, etc.).

FIG. 5E shows an illustration of exemplary results of a further detailed analysis of claims data based on service lines (e.g., cancer). In some embodiments, the CD3A allows the further processing of the extracted claims data set for particular service lines (e.g., oncology, orthopedics), and subservice lines (e.g. breast or prostate cancers) to generate data including patient counts, claims counts, dollars amounts and segmentation on a combination of granular elements of the claims data including procedures, sites of service, provider classifications and other data to obtain detailed information on the relationship of the service lines to multiple providers, subservice lines, in and out of network providers, claims amounts, types of procedures, and combinations of these and other data for refined analytical outputs. For example, the analysis may reveal data such as the total number of subservice line referrals, the number and/or the value of associated procedures, the number of referrals associated with the claim and procedures, and the sites of service, and/or the like. In some instances, such sub service line data may be broken down or grouped by different parameters. These parameters may be dates of service, in or out of network status, location of service, etc. For example, the analyzed claims data may show the count of subservice line claims by procedure and provider. Similarly, the analyzed service and subservice line data may also show how much dollar value is associated with in network claims from a particular provider.

FIG. 5F shows an illustration of exemplary results of analysis of extracted claims data to determine provider score with respect to referral volume, loyalty, influence, etc., of providers. In some embodiments, the CD3A allows for the processing of the extracted claims data to determine loyalty and volume measurements for particular providers to create a co-dynamic score on provider. For example, the analysis may reveal data such as the number of outbound referrals by a particular provider, by various service lines, by affinity, specialty, and/or the like. In some instances, the data may be grouped by different parameters. These parameters may be inbound or outbound referrals, service or sub service lines, in or out of network status, dates of service, etc. For example, the analyzed claims data may show the count of outbound referrals by provider and specialty, yielding a measure of provider loyalty and volume. Similarly, the analyzed referral data may also show how many claims are referred from a provider based on affinity. In some instances, the data may be classified based on the type of service or subservice line or by provider specialty.

FIG. 5G shows an illustration of exemplary results network analysis of extracted claims data and other sources of patient and market information including but not limited to provider patient data, licensed market data, etc., that identifies the number of patients, procedures, and dollars leaked and/or allocated in a particular market to competitive providers. In some embodiments, the CD3A allows for the processing of the extracted claims data and other patient and market data for a set of providers (e.g., physicians practicing in a geographic area defined by, for example, zip codes) to obtain detailed information on the relationship of the providers to referrals to competitive hospitals and practices. For example, the analysis may reveal referral data such as the total number of referrals made in a particular zip code to competitive hospitals based on the procedure and specialty of the referring providers, the value of these referrals, and/or the like. In some instances, such leakage data may be broken down or grouped by different parameters. These parameters may be service lines, sub service lines, specialty, zip code, etc. For example, the analyzed leakage data may show the count of referrals from a provider that are outside the provider network, and for a particular practice. The analyzed data may also show the trend of referral volume by specialty for in network and out of network referrals.

In some embodiments, a claims analytics processor-implemented method, comprising the extraction of claims data from a plurality of health insurance claim forms and/or healthcare market data sources, said claim forms and/or healthcare market data sources classified based on one or more selection criteria is disclosed. Such a method comprises the analysis of the extracted claims data to identify longitudinal referral records of patients based on customizable referral logic, and the aggregation of the longitudinal referral records of patients to establish a healthcare market profile related to one or more of service lines, providers, practices, and/or payors. Further, the method includes the identification of opportunity category determinants from the healthcare market profile based on one or more client rules, said determinants configured to characterize fields of the opportunity category related to the client. In addition, the method includes the generation of ratings of measures of the opportunity categories based on the opportunity category determinants so as to trigger actionable alerts according to a predetermined threshold of the measures. The method further comprises the display of the healthcare market profile and/or the generated ratings of measures in an interactive setting configured to present an amalgamated and pictorial view of provider referral chains, referral volumes by service lines, service sites, market leakages, ratings, and/or market areas.

In some instances, the one or more selection criteria comprise a geographic market area and/or a temporal range, where the geographic market area is defined by ZIP codes, and the length, upper limit and/or lower limit of the temporal range is health service line dependent. In some implementations, analyzing the extracted claims data from the plurality of health insurance claim forms comprises one or more of: identifying same providers on the plurality of claim forms by comparing National Provider Identifiers from the extracted claims data, identifying similar service lines on the plurality of claim forms based on current procedural terminology (CPT) codes, diagnostic related group (DRG) codes, and/or international classification of diseases (ICD) codes from the extracted claims data, and interrogating the claims data for one or more pairwise relations between patient visits to healthcare providers. The customizable referral logic determines fidelity of characteristics of the one or more pairwise relations between the healthcare providers to characteristics of a referral relationship so as to form the longitudinal referral records from pairwise relations with high fidelity to a referral relationship.

In some instances, the healthcare market profile comprises at least one of a network of provider and/or practice referrals and attributes of an individual provider, practice, payor and/or service line. The attributes of the individual providers further comprise data on amount, value, service line, destination, and/or payors of the referrals of the individual provider to other providers.

In some embodiments, the opportunity category comprises reduction of referral leakage related to the client, the fields of the opportunity category comprise source, volume, and/or value of the referral leakage, and the opportunity category determinants specify provider, practice and/or service line data related to the referral leakage, said data including identifiers of the providers, practices and/or service lines that are sources of the referral leakage, and/or amounts of the volume and/or value of the providers, the practices and/or the service lines that are sources of the referral leakage. In yet some instances, the opportunity category comprises business acquisition at a market area by the client, the fields of the opportunity category comprise source, volume, and/or value of referrals in the market area, and the opportunity category determinants specify provider, practice and/or service line data related to the referrals, said data including identifiers of providers, practices and/or service lines that are sources of the referrals in the market area, and/or amounts of the volume and/or value of referrals according to the providers, practices and/or service lines.

In some instances, a measure of an opportunity category comprises one or more of: scores indicating referral loyalty level and/or referral volume of a provider in a market area and/or in a service line to the client, and scores indicating referral influence level of a provider in a market area and/or in a service line, said influence level determined based on at least one of value, volume, payor type, and/or number of destinations of referrals by the provider.

In some embodiments, a claims analytics processor-implemented method, comprising extracting claims data from a plurality of health insurance claim forms, said claim forms selected based on shared geographic market area and shared temporal window of the claim forms is disclosed. The method further includes analyzing the extracted claims data to identify longitudinal referral records of patient visits to providers, and determining characteristics of the referrals in the longitudinal referral records that match some or all of characteristics of a referral relationship so as to select longitudinal referral records that comprise referral relationships. In some instances, the method also includes aggregating the selected longitudinal referral records to establish a network of referrals based on one or more of service lines, providers, practices, and/or payors, identifying, from the network of referrals, at least one of loyalty to a client, influence in a market area and/or service line, and volume of referrals of a referring provider, and generating provider scores indicating the loyalty, the volume, and/or the influence of the referring provider so as to trigger actionable alerts presented to the client device 101. In addition, in some instances, the method further comprises displaying the network of referrals and/or the provider scores in an interactive setting configured to present an amalgamated and pictorial view of provider referral chains, referral volumes by service lines, service sites, market leakages, ratings, and/or market areas.

In some instances, selecting the longitudinal referral records that comprise referral relationships comprises excluding from the longitudinal referral records referrals for one or more of diagnostic imaging, physical therapy, and routine diagnostic work. In addition, identifying the loyalty of the referring provider to the client comprises determining the proportion of referrals from the referring provider to other providers in a provider network of the client to referrals from the referring provider to other providers outside the provider network of the client based on volume and/or value of the referrals referred to the provider network and outside the provider network. In some instances, identifying the influence in a market area and/or service line of the referring provider comprises determining number of providers in the network of referrals receiving referrals from the referring provider, and/or value of referrals received by providers in the network of referrals from the referring provider.

In some embodiments, a claims analytics system is disclosed. The system comprises a memory, and a processor disposed in communication with said memory, and configured to issue a plurality of processing instructions stored in the memory. In some instances, the processor issues instructions to extract claims data from a plurality of health insurance claim forms, said claim forms selected based on shared geographic market area and shared temporal window of the claim forms. Further, the instructions include to analyze the extracted claims data to identify longitudinal referral records of patient visits to providers, and determine characteristics of the referrals in the longitudinal referral records that match some or all of characteristics of a referral relationship so as to select longitudinal referral records that comprise referral relationships. Further, the processor issues instructions to aggregate the selected longitudinal referral records to establish a network of referrals based on one or more of service lines, providers, practices, and/or payors; identify, from the network of referrals, at least one of loyalty to a client, influence in a market area and/or service line, and volume of referrals of a referring provider; and generate provider scores indicating the loyalty, the volume, and/or the influence of the referring provider so as to trigger actionable alerts presented to the client device 101.

In some embodiments, a processor-readable non-transitory claims analytics medium storing processor-issuable instructions to extract claims data from a plurality of health insurance claim forms, said claim forms selected based on shared geographic market area and shared temporal window of the claim forms is disclosed. In some instances, the instructions include to analyze the extracted claims data to identify longitudinal referral records of patient visits to providers, and determine characteristics of the referrals in the longitudinal referral records that match some or all of characteristics of a referral relationship so as to select longitudinal referral records that comprise referral relationships. Further, the instructions include to aggregate the selected longitudinal referral records to establish a network of referrals based on one or more of service lines, providers, practices, and/or payors; identify, from the network of referrals, at least one of loyalty to a client, influence in a market area and/or service line, and volume of referrals of a referring provider; and generate provider scores indicating the loyalty, the volume, and/or the influence of the referring provider so as to trigger actionable alerts presented to the client device lot.

### CD3A Controller

FIG. 6 shows a block diagram illustrating embodiments of a CD3A controller. In this embodiment, the CD3A controller 601 may serve to aggregate, process, store, search, serve, identify, instruct, generate, match, and/or facilitate interactions with a computer through various technologies, and/or other related data. The CD3A can, for example, be configured such that the various components described herein execute on both client device 101 and CD3A server 102. Because each component of the CD3A may be distributed, as described below, the client device and the CD3A server 203 may perform portions of the program logic assigned to them or portions of the program logic normally assigned to the other. In another example, the CD3A CDEI Component 641 (described above with respect to FIG. 2) can execute on smart phone 302 as shown. In an alternative configuration, the CD3A CDEI Component 641 may be installed on CD3A server 102 and provide services to client device via the networked program execution capabilities described below.

Typically, users, which may be people and/or other systems, may engage information technology systems (e.g., computers) to facilitate information processing. In turn, computers employ processors to process information; such processors 603 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 629 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the CD3A controller 601 may be connected to and/or communicate with entities such as, but not limited to: one or more users from user input devices 611; peripheral devices 612; an optional cryptographic processor device 628; and/or a communications network 613.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The CD3A controller 601 may be based on computer systems that may comprise, but are not limited to, components such as: a computer systemization 602 connected to memory 629.

### Computer Systemization

A computer systemization 602 may comprise a clock 630, central processing unit (“CPU(s)” and/or “processor(s)” (these terms are used interchangeable throughout the disclosure unless noted to the contrary)) 603, a memory 629 (e.g., a read only memory (ROM) 606, a random access memory (RAM) 605, etc.), and/or an interface bus 607, and most frequently, although not necessarily, are all interconnected and/or communicating through a system bus 604 on one or more (mother)board(s) 602 having conductive and/or otherwise transportive circuit pathways through which instructions (e.g., binary encoded signals) may travel to effectuate communications, operations, storage, etc. The computer systemization may be connected to a power source 686; e.g., optionally the power source may be internal. Optionally, a cryptographic processor 626 and/or transceivers (e.g., ICs) 674 may be connected to the system bus. In another embodiment, the cryptographic processor and/or transceivers may be connected as either internal and/or external peripheral devices 612 via the interface bus I/O. In turn, the transceivers may be connected to antenna(s) 675, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing CD3A controller to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 629 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the CD3A controller and beyond through various interfaces. Should processing requirements dictate a greater amount speed and/or capacity, distributed processors (e.g., Distributed CD3A), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the CD3A may be achieved by implementing a microcontroller such as CAST's R8051XC2 microcontroller; Intel's MCS 51 (i.e., 8051 microcontroller); and/or the like. Also, to implement certain features of the CD3A, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the CD3A component collection (distributed or otherwise) and/or features may be implemented via the microprocessor and/or via embedded components; e.g., via ASIC, coprocessor, DSP, FPGA, and/or the like. Alternately, some implementations of the CD3A may be implemented with embedded components that are configured and used to achieve a variety of features or signal processing.

Depending on the particular implementation, the embedded components may include software solutions, hardware solutions, and/or some combination of both hardware/software solutions. For example, CD3A features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the CD3A features. A hierarchy of programmable interconnects allow logic blocks to be interconnected as needed by the CD3A system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the CD3A may be developed on regular FPGAs and then migrated into a fixed version that more resembles ASIC implementations. Alternate or coordinating implementations may migrate CD3A controller features to a final ASIC instead of or in addition to FPGAs. Depending on the implementation all of the aforementioned embedded components and microprocessors may be considered the “CPU” and/or “processor” for the CD3A.

### Power Source

The power source 686 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 686 is connected to at least one of the interconnected subsequent components of the CD3A thereby providing an electric current to all subsequent components. In one example, the power source 686 is connected to the system bus component 604. In an alternative embodiment, an outside power source 686 is provided through a connection across the I/O 608 interface. For example, a USB and/or IEEE 1394 connection carries both data and power across the connection and is therefore a suitable source of power.

### Interface Adapters

Interface bus(ses) 607 may accept, connect, and/or communicate to a number of interface adapters, conventionally although not necessarily in the form of adapter cards, such as but not limited to: input output interfaces (I/O) 608, storage interfaces 609, network interfaces 610, and/or the like. Optionally, cryptographic processor interfaces 627 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 609 may accept, communicate, and/or connect to a number of storage devices such as, but not limited to: storage devices 614, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 610 may accept, communicate, and/or connect to a communications network 613. Through a communications network 613, the CD3A controller is accessible through remote clients 633b (e.g., computers with web browsers) by users 633a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed CD3A), architectures may similarly be employed to pool, load balance, and/or otherwise increase the communicative bandwidth required by the CD3A controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 610 may be used to engage with various communications network types 613. For example, multiple network interfaces may be employed to allow for the communication over broadcast, multicast, and/or unicast networks.

Input Output interfaces (I/O) 608 may accept, communicate, and/or connect to user input devices 611, peripheral devices 612, cryptographic processor devices 628, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 611 often are a type of peripheral device 512 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 612 may be connected and/or communicate to I/O and/or other facilities of the like such as network interfaces, storage interfaces, directly to the interface bus, system bus, the CPU, and/or the like. Peripheral devices may be external, internal and/or part of the CD3A controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the CD3A controller may be embodied as an embedded, dedicated, and/or monitor-less (i.e., headless) device, wherein access would be provided over a network interface connection.

Cryptographic units such as, but not limited to, microcontrollers, processors 626, interfaces 627, and/or devices 628 may be attached, and/or communicate with the CD3A controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 629. However, memory is a fungible technology and resource, thus, any number of memory embodiments may be employed in lieu of or in concert with one another. It is to be understood that the CD3A controller and/or a computer systemization may employ various forms of memory 629. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 629 will include ROM 606, RAM 605, and a storage device 614. A storage device 614 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 629 may contain a collection of program and/or database components and/or data such as, but not limited to: operating system component 615; information server component 616; user interface component 617; CD3A database component 619; cryptographic server component 620; CDEI component 641; CDAA component 642; and/or the like (i.e., collectively a component collection). The aforementioned components may be incorporated into (e.g., be sub-components of), loaded from, loaded by, or otherwise operatively available to and from the CD3A component(s) 635.

Any component may be stored and accessed from the storage devices and/or from storage devices accessible through an interface bus. Although program components such as those in the component collection, typically, are stored in a local storage device 614, they may also be loaded and/or stored in other memory such as: remote “cloud” storage facilities accessible through a communications network; integrated ROM memory; via an FPGA or ASIC implementing component logic; and/or the like.

### Operating System Component

The operating system component 615 is an executable program component facilitating the operation of the CD3A controller. Typically, the operating system facilitates access of I/O, network interfaces, peripheral devices, storage devices, and/or the like. The operating system may be a highly fault tolerant, scalable, and secure system such as: Unix and Unix-like system distributions (such as AT&Ts UNIX; Berkley Software Distribution (BSD) variations such as FreeBSD, NetBSD, OpenBSD, and/or the like; Linux distributions such as Red Hat, Debian, Ubuntu, and/or the like); and/or the like operating systems. However, more limited and/or less secure operating systems also may be employed such as Apple OS-X, Microsoft Windows 2000/2003/3.1/95/98/CE/Millenium/NT/Vista/XP/Win7 (Server), and/or the like. An operating system may communicate to and/or with other components in a component collection, including itself, and/or the like. Most frequently, the operating system communicates with other program components, user interfaces, and/or the like. The operating system, once executed by the CPU, may enable the interaction with communications networks, data, I/O, peripheral devices, program components, memory, user input devices, and/or the like. The operating system may provide communications protocols that allow the CD3A controller to communicate with other entities through a communications network 613. Various communication protocols may be used by the CD3A controller as a subcarrier transport mechanism for interaction, such as, but not limited to: multicast, TCP/IP, UDP, unicast, and/or the like.

### Information Server Component

An information server component 616 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HITPS), Secure Socket Layer (SSL), messaging protocols (e.g., ICQ, Internet Relay Chat (IRC), Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Representational State Transfer (REST) and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the CD3A controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the CD3A database component 619, operating system component 615, other program components, user interfaces, and/or the like.

Access from the Information Server Component 616 to the CD3A database component 619 may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the CD3A. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the CD3A as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser. Also, an information server may contain, communicate, generate, obtain, and/or provide program component, system, user, and/or data communications, requests, and/or responses.

### User Interface Component

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows, web interface libraries such as, but not limited to, Dojo, jQuery UI, MooTools, Prototype, script.aculo.us, SWFObject, Yahoo! User Interface, any of which may be used and provide a baseline and means of accessing and displaying information graphically to users.

A user interface component 617 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating system component 615, other program components, and/or the like. The user interface may contain, communicate, generate, obtain, and/or provide program component, system, user, and/or data communications, requests, and/or responses.

### Cryptographic Server Component

A cryptographic server component 620 is a stored program component that is executed by a CPU 603, cryptographic processor 626, cryptographic processor interface 627, cryptographic processor device 628, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael (AES), RSA, Secure Hash Algorithm (SHA), Secure Socket Layer (SSL), Secure Hypertext Transfer Protocol (HTTPS), and/or the like. Employing such encryption security protocols, the CD3A may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the CD3A component to engage in secure transactions if so desired. The cryptographic component facilitates the secure accessing of resources on the CD3A and facilitates the access of secured resources on remote systems; i.e., it may act as a client and/or server of secured resources. Most frequently, the cryptographic component communicates with information server component 616, operating system component 615, other program components, and/or the like. The cryptographic component may contain, communicate, generate, obtain, and/or provide program component, system, user, and/or data communications, requests, and/or responses.

### CD3A Database Component

The CD3A database component 619 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the CD3A database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 619 includes several tables 619a-j. A Clients table 619a may include fields such as, but not limited to: client_id, NPI, business_name, contact_name, state, address_firstline, address_secondline, zipcode, devices_list, contact_info, contact_type, alt_contact_info, alt_contact_type, and/or the like. A Devices table 619b may include fields such as, but not limited to: device_id, device_name, device_ip, device_type, device_model, operating_system, os_version, app_installed_flag, and/or the like. An Apps table 619c may include fields such as, but not limited to: app_id, app_name, app_role, app_capabilities, app_server_IP_address, and/or the like. A Providers table 619d may include fields such as, but not limited to: provider_id, provider_NPI, provider_name, provider_specialty, provider_subspecialty, network_affinity, address_firstline, address_secondline, zipcode, contact_info, contact_type, alt_contact_info, alt_contact_type, and/or the like. A Service Lines table 619e may include fields such as, but not limited to: service_line_id, sub_service_lines, service_line_ICD, service_line_CPT, service_line_DRG, service_line_types, service_line_providers, service_line_practices, service_line_loc, and/or the like. A Practices table 619f may include fields such as, but not limited to: practice_id, practice_NPI, practice_name, practice_location, practice_affinity, practice_speciality, practice_providers, practice_market_area, address_firstline, address_secondline, zipcode, contact_info, contact_type, alt_contact_info, alt_contact_type, and/or the like. A Payors table 619g may include fields such as, but not limited to: payor_id, payor_type, payor_name, payor_specialty, provider_rules, payor_address, contact_info, alt_contact_type, and/or the like. A Claims table 619h may include fields such as, but not limited to: claim_id, claim_form_type, claim_source, claim_provider, claim_referring, claim_referee, claim_amount, claim_specialty, claim_service_line, claim_sub_service_line, and/or the like. A Referrals table 619i may include fields such as, but not limited to: referral_id, referral_dates, referring_provider, referring_practice, referred_provider, referred_practice, referral_rules, referral_characteristics, referral_heirarchy, referral_specialty, referral_service_line, referral_sub_service_line, and/or the like. A Campaigns table 619j may include fields such as, but not limited to: campaign_id, campaign_date, campaign_target, campaign_liason, campaign_goal, referred_practice, campaign_service_line, campaign_sub_service_line, and/or the like. Any of the aforementioned tables may support and/or track multiple entities, accounts, users and/or the like.

In one embodiment, the CD3A database component may interact with other database systems. For example, when employing a distributed database system. In such an embodiment, queries and data access by any CD3A component may treat the combination of the CD3A database component results and results from a second segment in a distributed database system as an integrated database layer. Such a database layer may be accessed as a single database entity, for example through CD3A database component 619, by any CD3A component.

In one embodiment, user programs may contain various user interface primitives, which may serve to update the CD3A. Also, various accounts may require custom database tables depending upon the environments and the types of clients the CD3A may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 619a-j. The CD3A may be configured to keep track of various settings, inputs, and parameters via database controllers.

The CD3A database may communicate to and/or with other components in a component collection, including itself, and/or facilities of the like. Most frequently, the CD3A database communicates with the CD3A component, other program components, and/or the like. The database may contain, retain, and provide information regarding other nodes and data.

### CD3A Component

The CD3A component 635 is a stored program component that is executed by a CPU. In one embodiment, the CD3A component incorporates any and/or all combinations of the aspects of the CD3A that was discussed in the previous figures. As such, the CD3A affects accessing, obtaining and the provision of information, services, transactions, and/or the like across various communications networks. The features and embodiments of the CD3A discussed herein increase network efficiency by reducing data transfer requirements the use of more efficient data structures and mechanisms for their transfer and storage. As a consequence, more data may be transferred in less time, and latencies with regard to data processing operations and transactions, are also reduced. In many cases, such reduction in storage, transfer time, bandwidth requirements, latencies, etc., will reduce the capacity and structural infrastructure requirements to support the CD3A's features and facilities, and in many cases reduce the costs, energy consumption/requirements, and extend the life of CD3A's underlying infrastructure; this has the added benefit of making the CD3A more reliable. Similarly, many of the features and mechanisms are designed to be easier for users to use and access, thereby broadening the audience that may enjoy/employ and exploit the feature sets of the CD3A; such ease of use also helps to increase the reliability of the CD3A. In addition, the feature sets include heightened security as noted via the Cryptographic components 620, 626, 628 and throughout, making access to the features and data more reliable and secure.

The CD3A component may transform healthcare claims data input, and/or the like, via various components described herein, into analytics on networks of healthcare participants outputs. In one embodiment, the CD3A component 635 takes inputs (e.g., request for analytics on healthcare marketplace 104, health insurance claims forms query 105, and/or the like) etc., and transforms the inputs via various components (e.g., CDEI Component 641, CDAA Component 642, and/or the like), into outputs (e.g., healthcare marketplace intelligence 109, health insurance claims forms response 106 and/or the like).

The CD3A component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery; jQuery UI; MooTools; Prototype; script.aculo.us; Simple Object Access Protocol (SOAP); SWFObject; Yahoo! User Interface; and/or the like), WebObjects, and/or the like. In one embodiment, the CD3A server employs a cryptographic server to encrypt and decrypt communications. The CD3A component may communicate to and/or with other components in a component collection, including itself, and/or facilities of the like. Most frequently, the CD3A component communicates with the CD3A database component 619, operating system component 615, other program components, and/or the like. The CD3A may contain, communicate, generate, obtain, and/or provide program component, system, user, and/or data communications, requests, and/or responses.

### Distributed CD3A Components

The structure and/or operation of any of the CD3A node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the CD3A controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, Representational State Transfer (REST), process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTP post command, e.g.:
w3c -post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. Further, the parsing grammar may be used beyond message parsing, but may also be used to parse: databases, data collections, data stores, structured data, and/or the like. Again, the desired configuration will depend upon the context, environment, and requirements of system deployment.

### Additional CD3A Configurations

In order to address various issues and advance the art, the entirety of this application for CD3A (including the Cover Page, Title, Headings, Field, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a CD3A individual and/or enterprise user, database configuration and/or relational model, data type, data transmission and/or network framework, syntax structure, and/or the like, various embodiments of the CD3A, may be implemented that enable a great deal of flexibility and customization as described herein.

What is claimed is:

1. A processor-implemented method, comprising:
extracting claims data from a plurality of health insurance claim forms, the plurality of health insurance claim forms selected based on shared geographic market area and shared temporal window of the claim forms;
anonymizing the extracted claims data so as to provide data security to patient healthcare data for a plurality of patients;
assigning a plurality of aliases to the anonymized claims data, each alias from the plurality of aliases being uniquely associated with extracted claims data for a patient from the plurality of patients;
analyzing the anonymized extracted claims data to identify longitudinal referral records of patient visits to providers;
determining characteristics of referrals in the longitudinal referral records that match at least some characteristics of a referral relationship so as to select longitudinal referral records that comprise referral relationships;
aggregating the selected longitudinal referral records to establish a network of referrals based on one or more of service lines, providers, practices, and/or payors;
identifying, from the network of referrals, at least one of loyalty to a client, influence in a market area and/or service line, and/or volume of referrals of a referring provider; and
generating provider scores indicating the loyalty, the volume, and/or the influence of the referring provider so as to trigger actionable alerts presented to the client.

2. The method of claim 1, further comprising:
sending a signal such that the network of referrals and/or the provider scores are displayed in an interactive setting configured to present an amalgamated and pictorial view of provider referral chains, referral volumes by service lines, service sites, market leakages, ratings, and/or market areas.

3. The method of claim 1, wherein selecting the longitudinal referral records that having referral relationships includes excluding from the longitudinal referral records referrals for one or more of diagnostic imaging, physical therapy, and routine diagnostic work.

4. The method of claim 1, wherein identifying the loyalty of the referring provider to the client includes determining a proportion of referrals from the referring provider to other providers in a provider network of the client to referrals from the referring provider to other providers outside the provider network of the client based on volume and/or value of the referrals referred to the provider network and the referrals to other providers outside the provider network.

5. The method of claim 1, wherein identifying the influence in a market area and/or service line of the referring provider includes determining a number of providers in the network of referrals receiving referrals from the referring provider, and/or value of referrals received by providers in the network of referrals from the referring provider.

6. A processor-implemented method, comprising:
extracting claims data from a plurality of health insurance claim forms and/or healthcare market data sources, the plurality of health insurance claim forms and/or healthcare market data sources classified based on one or more selection criteria;
analyzing the extracted claims data to identify longitudinal referral records of patients based on customizable referral logic;
aggregating the longitudinal referral records of patients to establish a healthcare market profile related to one or more of service lines, providers, practices, and/or payors;
identifying opportunity category determinants from the healthcare market profile based on one or more client rules, the opportunity category determinants configured to characterize fields of opportunity category related to the client; and
generating ratings of measures of the opportunity categories based on the opportunity category determinants so as to trigger actionable alerts according to a predetermined threshold of the measures.

7. The method of claim 6, further comprising:
displaying the healthcare market profile and/or the generated ratings of measures in an interactive setting to present an amalgamated and pictorial view of provider referral chains, referral volumes by service lines, service sites, market leakages, ratings, and/or market areas.

8. The method of claim 6, wherein the one or more selection criteria include a geographic market area and/or a temporal range.

9. The method of claim 8, wherein the geographic market area is defined with respect to ZIP codes.

10. The method of claim 8, wherein length, upper limit and/or lower limit of the temporal range is health service line dependent.

11. The method of claim 6, wherein analyzing the extracted claims data from the plurality of health insurance claim forms includes identifying a common provider on at least two of the plurality of health insurance claim forms by comparing National Provider Identifiers from the extracted claims data.

12. The method of claim 6, wherein analyzing the extracted claims data from the plurality of health insurance claim forms includes identifying similar service lines on the plurality of claim forms based on current procedural terminology (CPT) codes, diagnostic related group (DRG) codes, and/or international classification of diseases (ICD) codes from the extracted claims data.

13. The method of claim 6, wherein analyzing the extracted claims data includes interrogating the extracted claims data for one or more pairwise relations between patient visits to healthcare providers.

14. The method of claim 13, wherein the customizable referral logic determines fidelity of characteristics of the one or more pairwise relations between the healthcare providers to characteristics of a referral relationship so as to form the longitudinal referral records from pairwise relations with high referral relationship fidelity.

15. The method of claim 6, wherein the healthcare market profile identifies at least one of a network of provider and/or practice referrals and attributes of an individual provider, practice, payor and/or service line.

16. The method of claim 15, wherein the attributes of individual providers includes data on amount, value, service line, destination, and/or payors of the referrals of the individual provider to other providers.

17. The method of claim 6, wherein:
the opportunity category includes reduction of referral leakage related to the client,
the fields of the opportunity category includes source, volume, and/or value of the referral leakage, and
the opportunity category determinants specify provider, practice and/or service line data related to the referral leakage, said provider, practice and/or service line data including identifiers of the providers, practices and/or service lines that are sources of the referral leakage, and/or amounts of the volume and/or value of the providers, the practices and/or the service lines that are sources of the referral leakage.

18. The method of claim 6, wherein:
the opportunity category includes business acquisition at a market area by the client,
the fields of the opportunity category includes source, volume, and/or value of referrals in the market area, and
the opportunity category determinants specify provider, practice and/or service line data related to the referrals, said provider, practice and/or service line data including identifiers of providers, practices and/or service lines that are sources of the referrals in the market area, and/or amounts of the volume and/or value of referrals according to the providers, practices and/or service lines.

19. The method of claim 6, wherein a measure of an opportunity category includes scores indicating referral loyalty level and/or referral volume of a provider in a market area and/or in a service line to the client.

20. The method of claim 6, wherein a measure of an opportunity category includes scores indicating referral influence level of a provider in a market area and/or in a service line, the referral influence level determined based on at least one of value, volume, payor type, and/or number of destinations of referrals by the provider.

21. A system, comprising
a memory;
a processor disposed in communication with said memory, and configured to issue a plurality of processing instructions stored in the memory, wherein the processor issues instructions to:
extract claims data from a plurality of health insurance claim forms, said claim forms selected based on shared geographic market area and shared temporal window of the claim forms;
analyze the extracted claims data to identify longitudinal referral records of patient visits to providers;
determine characteristics of the referrals in the longitudinal referral records that match some or all of characteristics of a referral relationship so as to select longitudinal referral records that comprise referral relationships;
aggregate the selected longitudinal referral records to establish a network of referrals based on one or more of service lines, providers, practices, and/or payors;
identify, from the network of referrals, at least one of loyalty to a client, influence in a market area and/or service line, and volume of referrals of a referring provider; and
generate provider scores indicating the loyalty, the volume, and/or the influence of the referring provider so as to trigger actionable alerts presented to the client.

22. A processor-readable non-transitory medium storing processor-issuable instructions to:
extract claims data from a plurality of health insurance claim forms, said claim forms selected based on shared geographic market area and shared temporal window of the claim forms;
analyze the extracted claims data to identify longitudinal referral records of patient visits to providers;
determine characteristics of the referrals in the longitudinal referral records that match some or all of characteristics of a referral relationship so as to select longitudinal referral records that comprise referral relationships;
aggregate the selected longitudinal referral records to establish a network of referrals based on one or more of service lines, providers, practices, and/or payors;
identify, from the network of referrals, at least one of loyalty to a client, influence in a market area and/or service line, and volume of referrals of a referring provider; and
generate provider scores indicating the loyalty, the volume, and/or the influence of the referring provider so as to trigger actionable alerts presented to the client.
